(19) United States
(12) Patent Application Publication
(10) Pub. No.: US 2016/0246775 A1
(43) Pub. Date: Aug. 25, 2016

(54) LEARNING APPARATUS AND LEARNING METHOD

(71) Applicant: FUJITSU LIMITED, Kawasaki-shi (JP)

(72) Inventor: Tomoya IWAKURA, Kawasaki (JP)

(73) Assignee: FUJITSU LIMITED, Kawasaki-shi (JP)

(21) Appl. No.: 15/001,436

(22) Filed: Jan. 20, 2016

(30) Foreign Application Priority Data
Feb. 19, 2015 (JP) 2015-030243

(51) Int. Cl. G06F 17/27; G06N 5/02

(52) U.S. Cl. CPC G06F 17/277; G06N 5/025

(57) ABSTRACT

A learning apparatus includes a memory and a processor to generate, based on a first example sentence containing a target word having a plurality of meanings belonging to different types, a first rule containing a first meaning of the target word in the first example sentence, and another word providing a clue for determining the first meaning, acquire a second example sentence, determine a second meaning of the target word in the second example sentence based on a word contained in the second example sentence and the first rule, generate a second rule pertaining to a correlation between the second meaning and the type, acquire a third example sentence, determine the third meaning of the target word in the third example sentence, and learn a third rule for determining a type of the target word based on the second rule, the third meaning, and the third example sentence.

### CROSS-REFERENCE TO RELATED APPLICATION

This application is based upon and claims the benefit of priority of the prior Japanese Patent Application No. 2015-030243, filed on Feb. 19, 2015, the entire contents of which are incorporated herein by reference.

### FIELD

The embodiments discussed herein are related to a technique for determining the type of a word.

### BACKGROUND

An apparatus that generates a rule for extracting unique expression by using a correct answer list indicating that a word contained in an example sentence falls under the unique expression is known. Related techniques are disclosed, for example, in Japanese Laid-open Patent Publication Nos. 2001-318792 and 2007-323475.

### SUMMARY

According to an aspect of the invention, a learning apparatus includes a memory and a processor coupled to the memory and configured to generate, based on a first example sentence containing a target word having a plurality of meanings belonging to different types, a first rule containing a first meaning of the target word in the first example sentence, and another word providing a clue for determining the first meaning, acquire a second example sentence having a context similar to that of the first example sentence, the second example sentence containing the target word and data identifying a type of a second meaning of the target word, determine the second meaning of the target word in the second example sentence based on a word contained in the second example sentence and the first rule, generate a second rule pertaining to a correlation between the second meaning and the type based on the second meaning of the target word in the second example sentence and the data, acquire a third example sentence containing the target word and another data identifying a type of a third meaning of the target word, determine the third meaning of the target word in the third example sentence based on a word contained in the third example sentence and the first rule, and learn a third rule for determining a type of the target word based on the second rule, the third meaning, and the third example sentence.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates an example of determining the type of unique expression;

FIG. 2 illustrates an example not falling under the unique expression;

FIG. 3 illustrates a module configuration example of a learning apparatus;

FIG. 4 is a diagram illustrating a processing flow of the learning apparatus;

FIG. 5 illustrates an example of a definition table;

FIG. 6 illustrates a module configuration example of a first preprocessing unit;

FIG. 7 illustrates an example of a first preprocessing flow;

FIG. 8 illustrates an example of first example sentence data;

FIG. 9 illustrates an example of a first example sentence;

FIG. 10 illustrates an example of the first example sentence;

FIG. 11 illustrates an example of the first example sentence;

FIG. 12 illustrates an example of first extracted data;

FIG. 13 illustrates an example of first rule data;

FIG. 14 illustrates a module configuration example of a second preprocessing unit;

FIG. 15 illustrates an example of a second preprocessing flow;

FIG. 16 illustrates an example of second example sentence data;

FIG. 17 illustrates an example of second extracted data;

FIG. 18 illustrates an example of learning data;

FIG. 19 illustrates an example of second rule data;

FIG. 20 illustrates an example of second rule data;

FIG. 21 illustrates a module configuration example of a main processing unit;

FIG. 22 illustrates an example of a main processing flow;

FIG. 23 illustrates an example of third example sentence data;

FIG. 24 illustrates an example of a third example sentence;

FIG. 25 illustrates an example of the third example sentence;

FIG. 26 illustrates an example of the third example sentence;

FIG. 27 illustrates an example of a main processing flow;

FIG. 28 illustrates an example of training data;

FIG. 29 illustrates an example of third extracted data;

FIG. 30 illustrates an example of third rule data;

FIG. 31 illustrates an example of third example sentence data;

FIG. 32 illustrates an example of a third example sentence;

FIG. 33 illustrates an example of training data;

FIG. 34 illustrates a module configuration example of a determination device;

FIG. 35 illustrates an example of an application processing flow;

FIG. 36 illustrates an example of target sentence data;

FIG. 37 illustrates an example of application data;

FIG. 38 illustrates an example of fourth extracted data;

FIG. 39 illustrates an example of result data;

FIG. 40 illustrates an example of output data;

FIG. 41 illustrates a module configuration example of a learning apparatus according to a second embodiment; and

FIG. 42 is a hardware configuration diagram of a computer.

### DESCRIPTION OF EMBODIMENTS

A word, which falls under unique expression in an example sentence, is not necessarily used as unique expression in another sentence as well.

Thus, it is not easy to automatically classify a word used in various ways.

According to an aspect of the embodiments, an object of the technique disclosed herein is to obtain a rule for performing more correct type classification of a word having a plurality of meanings.

### First Embodiment

The word “ [symbol] ” expressed with one Chinese character for the original meaning of “grain of rice” may be used as an abbreviation for “The United States of America” in Japanese. Hereinafter, an example of the circumstance where the word is used for the meaning of “government of The United States of America” instead of “grain of rice” is described. When used to mean “government of The United States of America”, this word falls under the type of the unique expression “ORGANIZATION”. Meanwhile, when used to mean “grain of rice”, this word does not fall under any type of the unique expression.

Hereinafter, an example of automatically determining whether the word “ [symbol] ” expressed with one Chinese character meaning “grain of rice” falls under the type of the unique expression “ORGANIZATION” is described. A word of the determination target is referred to as the target word.

When the target word falls under the type of the unique expression, an output sentence having a tag indicating the type of the unique expression is generated. On the other hand, when the target word does not fall under the type of the unique expression, the tag is not attached.

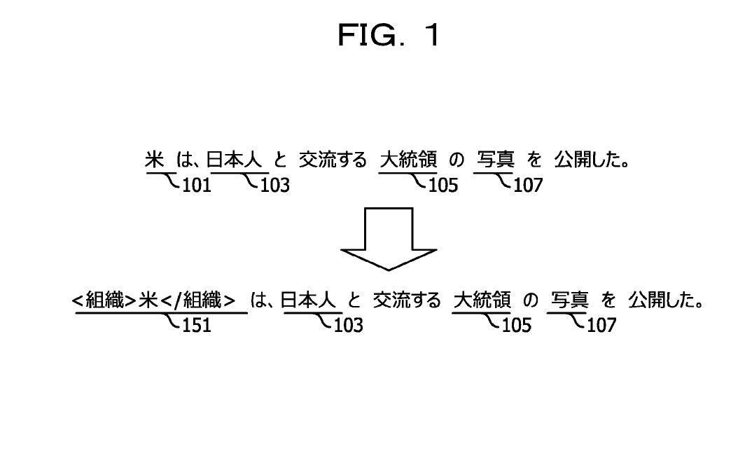

FIG. 1 illustrates an example of determining the type of the unique expression. The application target sentence in this example is “ [symbol] [symbol] [symbol] [symbol] ” (The United States of America released a picture of the president interacting with Japanese people) depicted on the upper part. In this embodiment, processing is performed by focusing on the noun contained in the sentence.

First, the noun among words contained in a sentence, is described. The application target sentence contains four nouns including a first noun 101, a second noun 103, a third noun 105, and a fourth noun 107. Among those nouns, the first noun 101 corresponds to the target word. The first noun 101 in this example is used to mean “government of The United States of America”. The first noun 101 is expressed with one Chinese character as illustrated.

The lower part of FIG. 1 illustrates an output sentence obtained by performing a determination processing for the sentence illustrated in the upper part. A first noun 151 in the lower part of FIG. 1 includes tags < [symbol] (ORGANIZATION)> and </ [symbol] (ORGANIZATION)> indicating that the first noun 101 corresponds to the unique expression of the ORGANIZATION type. Any word not corresponding to the target for determining the type of unique expression is not changed. Consequently, the second noun 103, the third noun 105 and the fourth noun 107 are the same as in the upper part.

The second noun 103 is “ [symbol] ” expressed with three Chinese characters as illustrated. The third noun 105 is “ [symbol] ” expressed with three Chinese characters as illustrated. The fourth noun 107 is “ [symbol] ” expressed with two Chinese characters as illustrated.

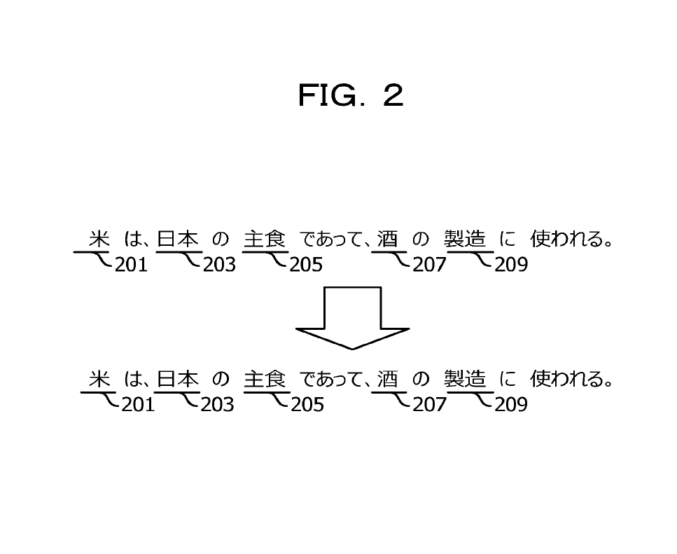

Next, a target word not falling under the unique expression is described with reference to FIG. 2. The application target sentence in this example is “ [symbol] [symbol] [symbol] [symbol] ” (Rice is the staple food of Japan and is used for production of sake) depicted in the upper part. The application target sentence contains five nouns including a first noun 201, a second noun 203, a third noun 205, a fourth noun 207, and a fifth noun 209. Among those nouns, the first noun 201 is the target word like the first noun 101 illustrated in FIG. 1. The first noun 201 in this example is used to mean “grain of rice”. That is, the first noun 201 in this example is used to express the original meaning thereof and does not fall under the unique expression.

The lower part of FIG. 2 illustrates an output sentence obtained by performing the determination processing for the sentence illustrated in the upper part. When the word of determination target does not fall under the type of unique expression, the tag is not attached thereto. Consequently, the first noun 201 is the same as in the upper part. The second noun 203, the third noun 205, the fourth noun 207, and the fifth noun 209, which do not fall under the type of unique expression, are also the same as in the upper part. However, when the target word does not fall under the type of unique expression, tags <O> and </O> indicating that the word does not fall under the type of the unique expression may be attached thereto.

The second noun 203 is “ [symbol] ” expressed with two Chinese characters as illustrated. The third noun 205 is “ [symbol] ” expressed with two Chinese characters as illustrated. The fourth noun 207 is “ [symbol] ” expressed with one Chinese character as illustrated. The fifth noun 209 is “ [symbol] ” expressed with two Chinese characters as illustrated.

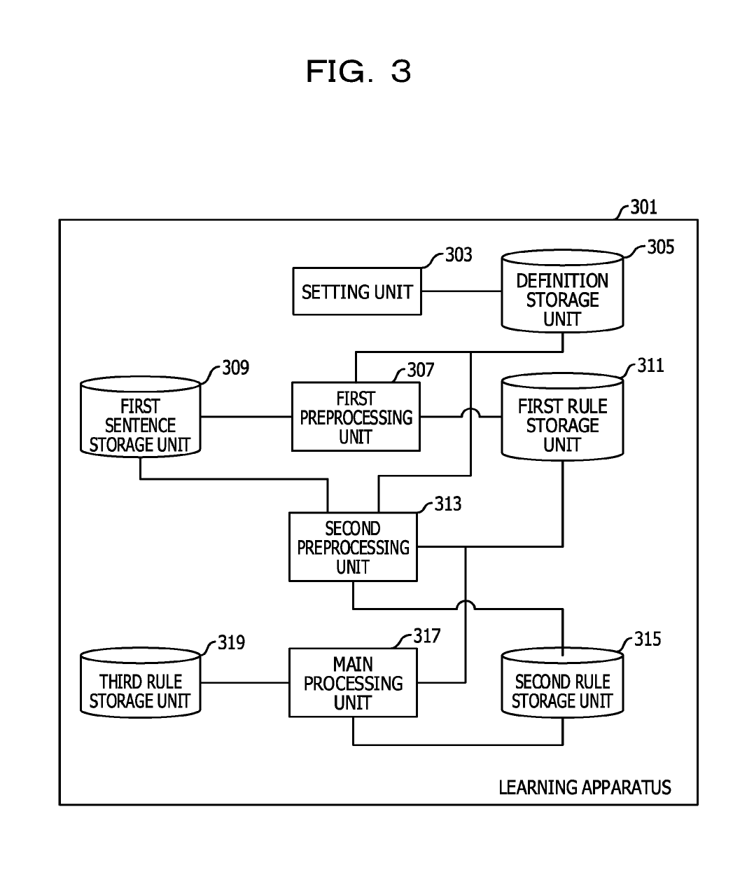

Next, a learning apparatus performing machine learning is described. FIG. 3 illustrates a module configuration example of a learning apparatus 301. The learning apparatus 301 includes a setting unit 303, a definition storage unit 305, a first preprocessing unit 307, a first sentence storage unit 309, a first rule storage unit 311, a second preprocessing unit 313, a second rule storage unit 315, a main processing unit 317, and a third rule storage unit 319.

The learning apparatus 301 is a computer configured to generate a label determiner by machine learning. The setting unit 303 is configured to set the content of the definition data. The definition storage unit 305 is configured to store the definition data. The first preprocessing unit 307 is configured to generate a meaning determiner including first rule data based on a first example sentence stored in the first sentence storage unit 309. The processing executed by the first preprocessing unit 307 is referred to as the first preprocessing. The first sentence storage unit 309 is configured to store first example sentence data including a plurality of first example sentences. The first rule storage unit 311 is configured to store the first rule data. The second preprocessing unit 313 is configured to perform first machine learning for generating the label determiner including second rule data based on a second example sentence generated from a first example sentence and first rule data. The processing executed by the second preprocessing unit 313 is referred to as the second preprocessing. The second rule storage unit 315 is configured to store the second rule data. The main processing unit 317 is configured to perform second machine learning for generating a label determiner including third rule data based on a third example sentence, first rule data and second rule data by using the second rule data as a default value of rule data. The processing executed by the main processing unit 317 is referred to as the main processing. The third rule storage unit 319 is configured to store the third rule data. The data and processing described above are described in detail below.

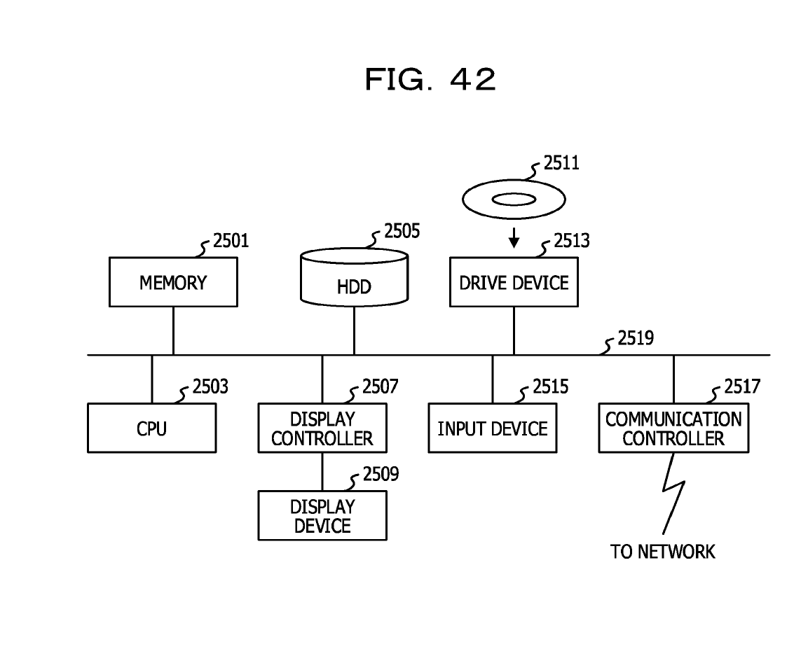

The setting unit 303, the first preprocessing unit 307, the second preprocessing unit 313, and the main processing unit 317 are implemented by using a hardware resource (for example, FIG. 42) and a program which causes a processor to execute the processings described below.

The definition storage unit 305, the first sentence storage unit 309, the first rule storage unit 311, the second rule storage unit 315, and the third rule storage unit 319 are implemented by using a hardware resource (for example, FIG. 42).

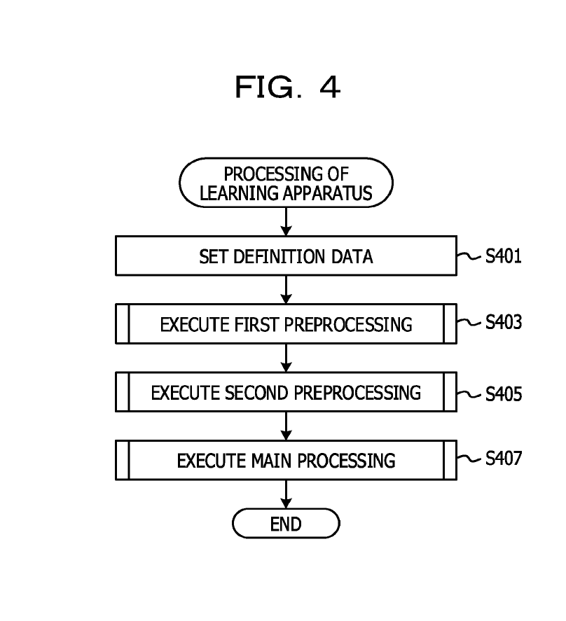

FIG. 4 illustrates a processing flow of the learning apparatus 301. The setting unit 303 sets the definition content related to the target word into definition data stored in the definition storage unit 305 (S401). The setting unit 303 receives the definition content, for example, via a user interface, a recording medium or a communication medium.

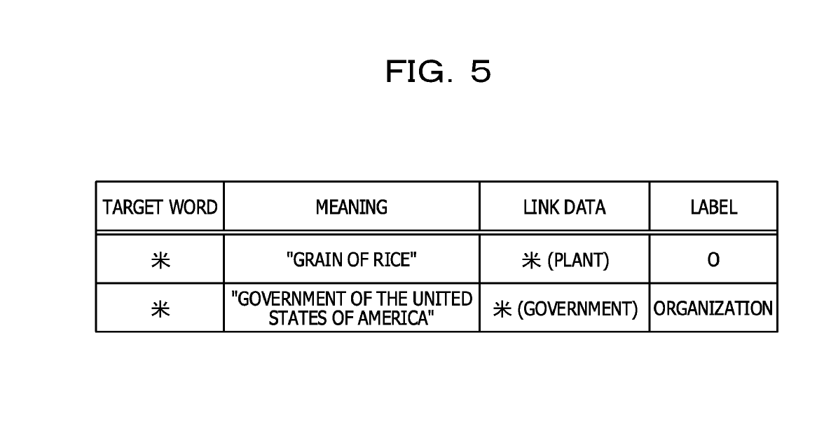

FIG. 5 illustrates an example of the definition table. The definition table includes a record corresponding to the meaning of the target word. A record of the definition table includes a field for setting the target word, a field for setting the meaning, a field for setting the link data, and a field for setting the label. The link data is data for specifying the link destination of the term in an existing data base such as, for example, a dictionary site. This example is based on the premise that the article of the dictionary site indicates a different link data depending on whether the target word is used to mean “grain of rice” or “government of The United States of America”.

The first record in the example of FIG. 5 indicates that when the target word is used to mean “grain of rice” in the dictionary site, data linked to an article describing a meaning identified with “plant” is added to the target word. Further, the first record in the example of FIG. 5 indicates that the meaning identified with “plant” corresponds to the label “O”. The label “O” means “other” which indicates that the word does not fall under the type of unique expression “ [symbol] ” (ORGANIZATION) in this example. The label is an example of the type for classifying the word.

The second record in the example of FIG. 5 indicates that when the target word is used to mean “government of The United States of America” in the dictionary site, data linked to an article describing the meaning identified with “government” is added to the target word. Further, the second record in the example of FIG. 5 indicates that the meaning identified with “plant” corresponds to the label “ [symbol] (ORGANIZATION)”.

Description is continued by referring back to FIG. 4. The first preprocessing unit 307 executes the first preprocessing (S403). The first preprocessing unit 307 generates a meaning determiner based on a first example sentence stored in the first sentence storage unit 309 in the first preprocessing. Specifically, first rule data used by the meaning determiner is obtained.

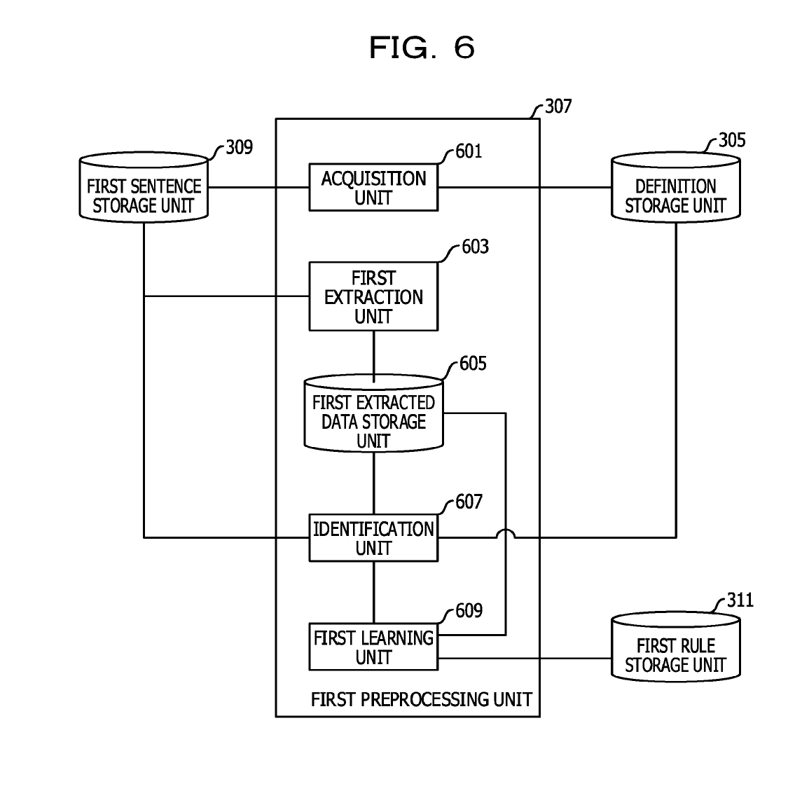

FIG. 6 illustrates a module configuration example of the first preprocessing unit 307. The first preprocessing unit 307 includes an acquisition unit 601, a first extraction unit 603, a first extracted data storage unit 605, an identification unit 607, and a first learning unit 609.

The acquisition unit 601 acquires a plurality of first example sentences including the target word to which the above link data is added. The first extraction unit 603 extracts a word providing a clue for the meaning determination out of the plurality of first example sentences. The first extracted data storage unit 605 stores first extracted data covering all words providing a clue for the meaning determination. The identification unit 607 identifies the meaning of respective target words based on link data included in each of the plurality of first example sentences. The first learning unit 609 learns a first rule for the meaning determination of the target word based on the association between the meaning of the target word and the word providing a clue in each of the plurality of first example sentences. The data and processing described above are described in detail below.

The acquisition unit 601, the first extraction unit 603, the identification unit 607, and the first learning unit 609 are implemented by using a hardware resource (for example, FIG. 42) and a program which causes a processor to execute the processings described below.

The first extracted data storage unit 605 is implemented by using a hardware resource (for example, FIG. 42).

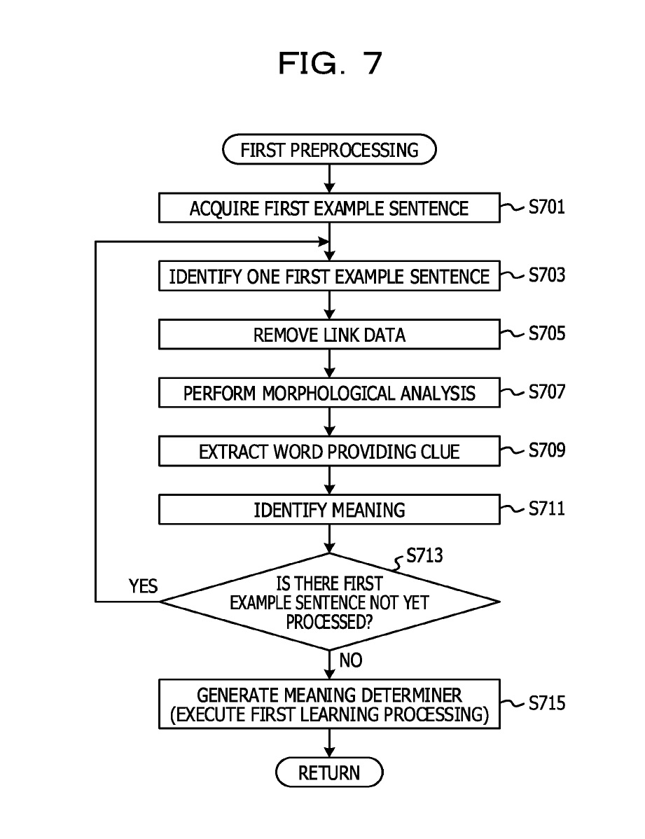

FIG. 7 illustrates an example of a first preprocessing flow. The acquisition unit 601 acquires the first example sentence and stores into the first sentence storage unit 309 (S701). The acquisition unit 601 may acquire the first example sentence from a database of a web site (for example, a dictionary site). Alternatively, the acquisition unit 601 may acquire the first example sentence from a dictionary database stored in a recording medium. Thus, with the first example sentence acquired from a database which systematizes general and broad-range knowledge, it is expected that a highly adaptable meaning determiner is generated. However, the acquisition unit 601 may acquire the first example sentence by using another method.

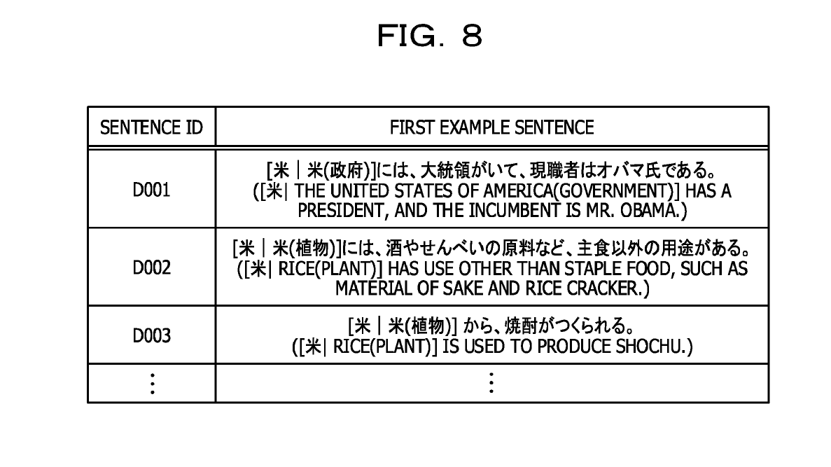

FIG. 8 illustrates an example of first example sentence data. The first example sentence data is provided with a record for each of first example sentences. The record stores a first example sentence associated with the sentence ID.

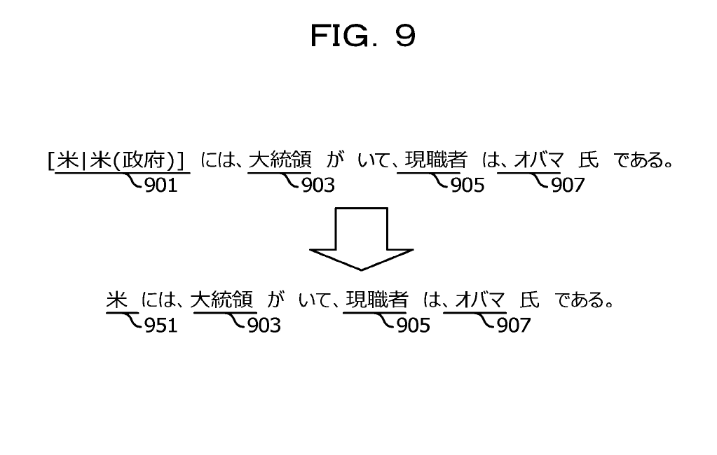

First, a first example sentence of the sentence ID D001 in the first example sentence data illustrated in FIG. 8 is described with reference to FIG. 9.

The first example sentence of the sentence ID D001 contains four nouns including a first noun 901, a second noun 903, a third noun 905, and a fourth noun 907. Among those nouns, the first noun 901 is the target word. The first noun 901 in this example is used to mean “government of The United States of America”. Therefore, link data for the article describing the meaning identified with “ [symbol] ” (hereinafter referred to as link data for “ [symbol] ”) is added to one Chinese character. The format of the link data is not limited to this example.

The lower part of FIG. 9 illustrates a first example sentence with the link data removed. A first noun 951 is normally expressed with the link data removed from the first noun 901 illustrated in the upper part. The second noun 903, the third noun 905 and the fourth noun 907 are the same as in the upper part.

In this example, except for the first noun 951 which corresponds to the target word, the second noun 903, the third noun 905 and the fourth noun 907 are extracted as words providing a clue for the meaning determination.

The second noun 903 is “ [symbol] ” expressed with three Chinese characters as illustrated. The third noun 905 is “ [symbol] ” expressed with three Chinese characters as illustrated. The fourth noun 907 is “ [symbol] ” expressed with three katakana characters as illustrated.

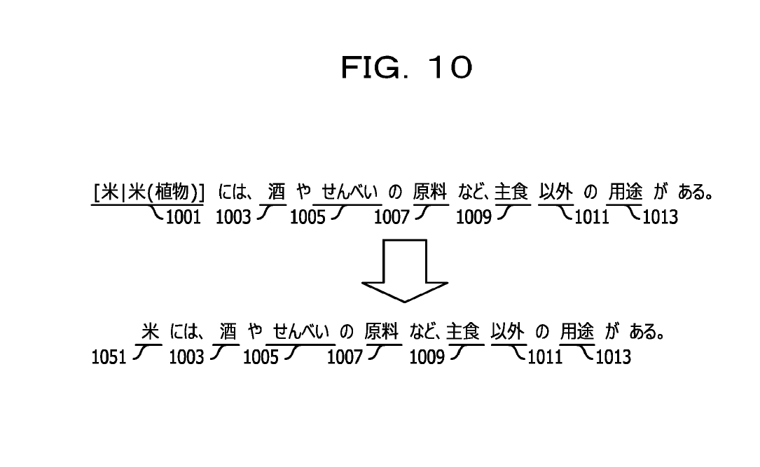

Next, a first example sentence of the sentence ID D002 in the first example sentence data illustrated in FIG. 8 is described with reference to FIG. 10.

The first example sentence of the sentence ID D002 contains seven nouns including a first noun 1001, a second noun 1003, a third noun 1005, a fourth noun 1007, a fifth noun 1009, a sixth noun 1011, and a seventh noun 1013. Among those nouns, the first noun 1001 is the target word. The first noun 1001 in this example is used to mean “grain of rice”. Therefore, link data for the article describing the meaning identified with “plant” (hereinafter referred to as link data for “plant”) is added to one Chinese character.

The lower part of FIG. 10 illustrates a first example sentence with the link data removed. A first noun 1051 is normally expressed with the link data removed from the first noun 1001 illustrated in the upper part. The second noun 1003, the third noun 1005, the fourth noun 1007, the fifth noun 1009, the sixth noun 1011 and the seventh noun 1013 are the same as in the upper part.

In this example, except for the first noun 1051 which corresponds to the target word, the second noun 1003, the third noun 1005, the fourth noun 1007, the fifth noun 1009, the sixth noun 1011, and the seventh noun 1013 are extracted as words providing a clue for the meaning determination.

The second noun 1003 is “ [symbol] ” expressed with one Chinese character as illustrated. The third noun 1005 is “ [symbol] ” expressed with four hiragana characters as illustrated. The fourth noun 1007 is “ [symbol] ” expressed with two Chinese characters as illustrated. The fifth noun 1009 is “ [symbol] ” expressed with two Chinese characters as illustrated. The sixth noun 1011 is “ [symbol] ” expressed with two Chinese characters as illustrated. The seventh noun 1013 is “ [symbol] ” expressed with two Chinese characters as illustrated.

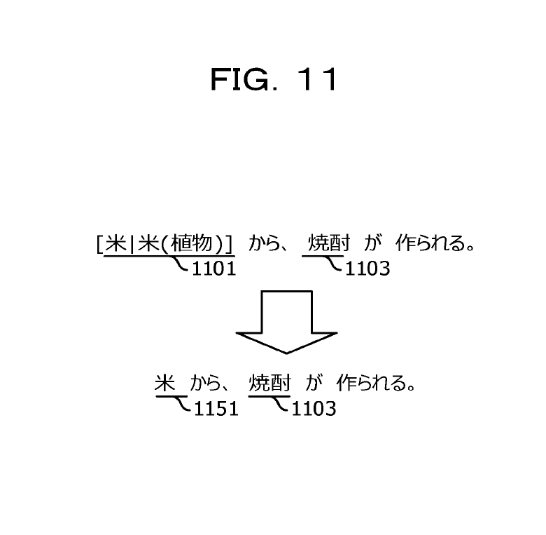

Finally, a first example sentence of the sentence ID D003 in the first example sentence data illustrated in FIG. 8 is described with reference to FIG. 11.

The first example sentence of the sentence ID D003 contains two nouns including a first noun 1101 and a second noun 1103. Among those nouns, the first noun 1101 is the target word. The first noun 1101 in this example is used to mean “grain of rice”. Therefore, link data for the article describing the meaning identified with “plant” is added to one Chinese character.

The lower part of FIG. 11 illustrates a first example sentence with the link data removed. The first noun 1151 is normally expressed with the link data removed from the first noun 1101 illustrated in the upper part. The second noun 1103 is the same as in the upper part.

In this example, except for the first noun 1151 which corresponds to the target word, the second noun 1103 is extracted as a word providing a clue for the meaning determination.

The second noun 1103 is “ [symbol] ” expressed with two Chinese characters as illustrated. Now, description of the first example sentence data ends.

Description is continued by referring back to FIG. 7. The first extraction unit 603 identifies one of first example sentences stored in the first sentence storage unit 309 (S703). The first extraction unit 603 removes link data from the first example sentence (S705). Then, the first extraction unit 603 performs morphological analysis of the first example sentence from which the link data is removed (S707). The first extraction unit 603 extracts a word providing a clue for the meaning determination from the result of morphological analysis (S709). Hereinafter, the word providing a clue for the meaning determination may be merely referred to as the clue.

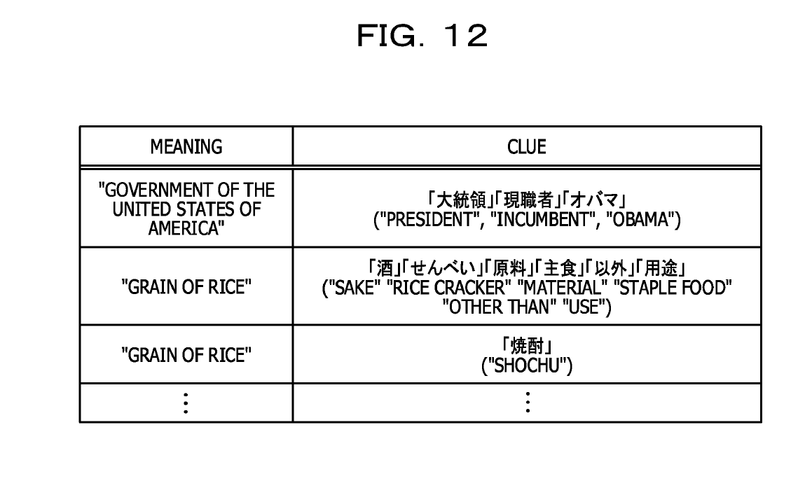

FIG. 12 illustrates an example of first extracted data. The first extracted data includes a record corresponding to the first example sentence. The record of the first extracted data includes a field for setting the meaning of the target word contained in the first example sentence and a field for setting one or more clue words contained in the first example sentence. The clue word in this example is a noun other than the target word. However, a word of a word class other than the noun may be used as the clue word.

The first record in the example of FIG. 12 indicates that the target word contained in the first example sentence of the sentence ID D001 is used to mean “government of The United States of America”. Further, the first record in the example of FIG. 12 indicates that nouns “ [symbol] ” [symbol] ” and “ [symbol] ” have been extracted from the first example sentence of the sentence ID D001 as a clue for the meaning determination of “government of The United States of America”.

The second record in the example of FIG. 12 indicates that the target word contained in the first example sentence of the sentence ID D002 is used to mean “grain of rice”. Further, the second record in the example of FIG. 12 indicates that nouns “ [symbol] ” “ [symbol] ” “ [symbol] ” “ [symbol] ” and “ [symbol] ” have been extracted from the first example sentence of the sentence ID D002 as a clue for the meaning determination of “grain of rice”.

The third record in the example of FIG. 12 indicates that the target word contained in the first example sentence of the sentence ID D003 is used to mean “grain of rice”. Further, the third record in the example of FIG. 12 indicates that the noun “ [symbol] ” has been extracted from the first example sentence of the sentence ID D003 as a clue for the meaning determination of “grain of rice”.

Description is continued by referring back to FIG. 7. The identification unit 607 identifies the meaning of the target word contained in the first example sentence identified in S703 based on the definition data stored in the definition storage unit 305 (S711). That is, the identification unit 607 identifies the meaning corresponding to the link data added to the target word. Then, the identification unit 607 sets the identified meaning to the first extracted data storage unit 605.

Then, the first extraction unit 603 determines whether there is a first example sentence not yet processed (S713). If determined that there is a first example sentence not yet processed, operation returns to the processing of S703 and repeats the above processing.

If determined that there is no first example sentence not yet processed, the first learning unit 609 generates the meaning determiner (S715). The first learning unit 609 performs machine learning, for example, by using a perceptron. In this embodiment, the processing of performing machine learning in S715 is referred to as the first learning processing.

Input of the meaning determiner corresponds to the clue in the first extracted data. Then, by giving the meaning in the first extracted data to the output of the meaning determiner, a first score indicating the relation between the clue and the meaning is determined. First rule data obtained by the first learning processing is stored in the first rule storage unit 311. The meaning determiner in this example includes first rule data.

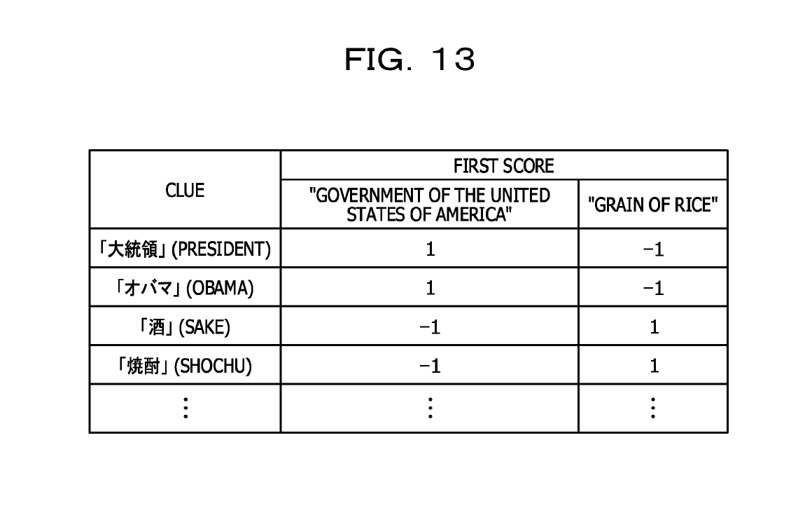

FIG. 13 illustrates an example of the first rule data. The first rule data includes a record for each of words providing a clue for the meaning determination. The record of the first rule data includes a field for setting the word providing a clue of the meaning determination, and a field for setting the first score assigned to the combination of the word and respective meanings.

The first score indicates the degree of the relation between the clue and the meaning in the combination. A positive first score indicates relatively frequent appearance of the clue and the meaning pertaining to the combination in the same sentence. That is, this means that if the first score is positive, selection of the meaning pertaining to the combination is affirmative based on the clue pertaining to the combination. On the other hand, a negative first score indicates relatively less frequent appearance of the clue and the meaning pertaining to the combination in the same sentence. That is, this means that if the first score is negative, selection of the meaning pertaining to the combination is negative based on the clue pertaining to the combination.

The first record in the example of FIG. 13 indicates that the first score “1” is assigned to the combination of the clue “ [symbol] ” for and the meaning “government of The United States of America”. The first record in the example of FIG. 13 indicates that the first score “−1” is assigned to the combination of the clue “ [symbol] ” and the meaning “grain of rice”. That is, this indicates that there is a high possibility that the target word contained in a sentence where the clue “ [symbol] ” appears is used to mean “government of The United States of America”, and that, to the contrary, there is a low possibility that the target word is used to mean “grain of rice”.

The second record in the example of FIG. 13 indicates that the first score “1” is assigned to the combination of the clue “ [symbol] ” and the meaning “government of The United States of America”. Further, the second record in the example of FIG. 13 indicates that the first score “−1” is assigned to the combination of the clue “ [symbol] ” and the meaning “grain of rice”. That is, this indicates that there is a high possibility that the target word contained in a sentence where the clue “ [symbol] ” appears is used to mean “government of The United States of America”, and that, to the contrary, there is a low possibility that the target word is used to mean “grain of rice”.

The third record in the example of FIG. 13 indicates that the first score “−1” is assigned to the combination of the clue “ [symbol] ” and the meaning “government of The United States of America”. Further, the third record in the example of FIG. 13 indicates that the first score “1” is assigned to the combination of the clue “ [symbol] ” and the meaning “grain of rice”. That is, this indicates that there is a high possibility that the target word contained in a sentence where the clue “ [symbol] ” appears is used to mean “government of The United States of America”, and that, to the contrary, there is a low possibility that the target word is used to mean “grain of rice”.

The fourth record in the example of FIG. 13 indicates that the first score “−1” is assigned to the combination of the clue “ [symbol] ” and the meaning “government of The United States of America”. Further, the fourth record in the example of FIG. 13 indicates that the first score “1” is assigned to the combination of the clue “ [symbol] ” and the meaning “grain of rice”. That is, this indicates that there is a low possibility that the target word contained in a sentence where the clue “ [symbol] ” appears is used to mean “government of The United States of America”, and that, to the contrary, there is a high possibility that the target word is used to mean “grain of rice”.

After completion of the first learning processing in S715 illustrated in FIG. 7, operation shifts to S405 illustrated in FIG. 4.

Description is continued by referring back to FIG. 4. The second preprocessing unit 313 executes a second preprocessing (S405). The second preprocessing unit 313 performs, in the second preprocessing, first machine learning for generating a label determiner based on a second example sentence generated from the first example sentence stored in the first sentence storage unit 309 and first rule data stored in the first rule storage unit 311. Second rule data obtained by the first learning processing is stored into the second rule storage unit 315.

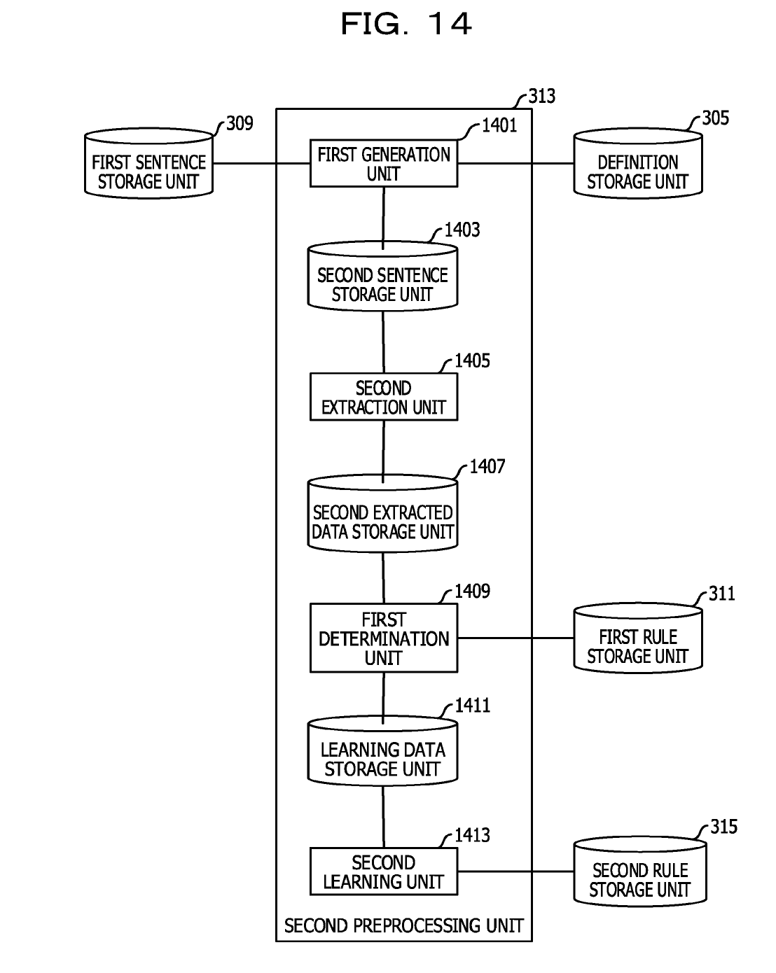

FIG. 14 illustrates a module configuration example of the second preprocessing unit 313. The second preprocessing unit 313 includes a first generation unit 1401, a second sentence storage unit 1403, a second extraction unit 1405, a second extracted data storage unit 1407, a first determination unit 1409, a learning data storage unit 1411, and a second learning unit 1413.

The first generation unit 1401 converts link data contained in each of the plurality of first example sentences to a label for classifying the target word and generates a second example sentence containing the label for classifying the target word. The second sentence storage unit 1403 stores second example sentence data including a plurality of second example sentences. The second extraction unit 1405 extracts a word providing a clue for the meaning determination from the plurality of second example sentences. The second extracted data storage unit 1407 stores second extracted data covering all words providing a clue for the meaning determination. The first determination unit 1409 determines the meaning of the target word contained in the second example sentence based on the clue word extracted from each of second example sentences in accordance with the first rule data. The learning data storage unit 1411 stores the learning data. The second learning unit 1413 learns a second rule determining the label, based on the association between a first feature determining the meaning of the target word in the second example sentence and the label of the target word. The data and processing described above are described in detail below.

The first generation unit 1401, the second extraction unit 1405, the first determination unit 1409, and the second learning unit 1413 are implemented by using a hardware resource (for example, FIG. 42) and a program which causes a processor to execute the processings described below.

The second sentence storage unit 1403, the second extracted data storage unit 1407, and the learning data storage unit 1411 are implemented by using a hardware resource (for example, FIG. 42).

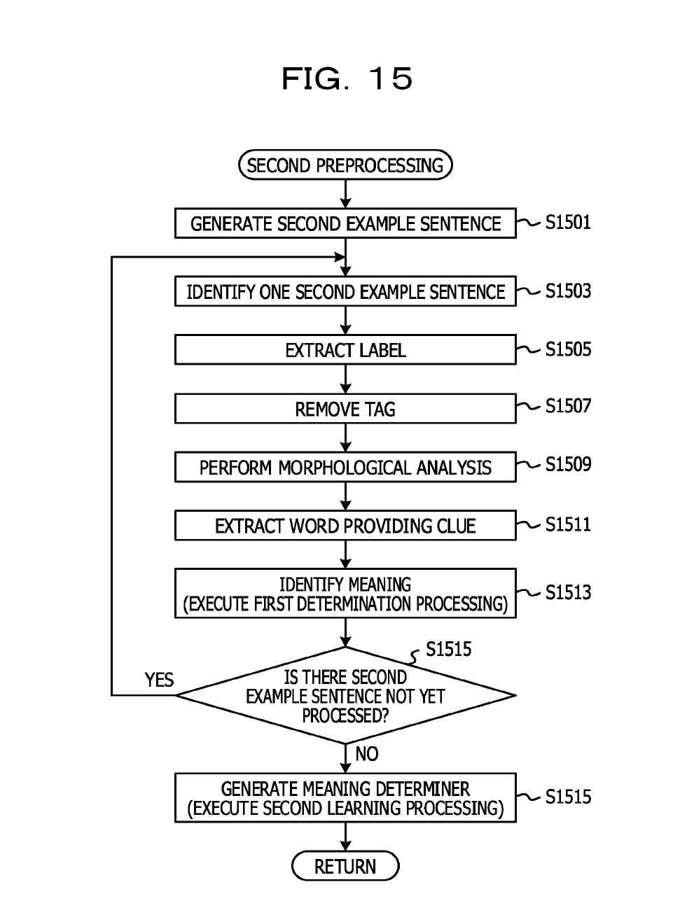

FIG. 15 illustrates an example of a second preprocessing flow. The first generation unit 1401 generates a second example sentence from first example sentences stored in the first sentence storage unit 309 (S1501). The generated second example sentence is stored into the second sentence storage unit 1403. Specifically, link data contained in the first example sentence is converted to a tag indicating the label, based on the definition storage unit 305.

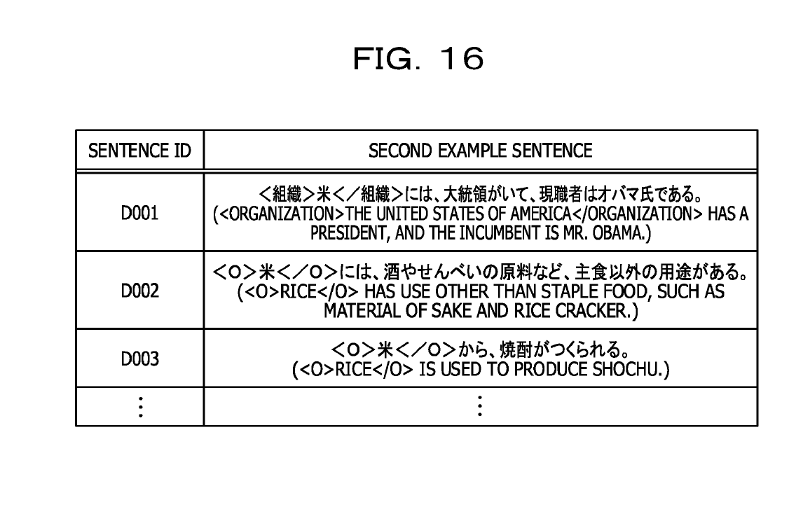

FIG. 16 illustrates an example of second example sentence data. The second example sentence data is provided with a record for each of second example sentences. The record stores a second example sentence associated with the sentence ID.

The first record in the example of FIG. 16 is provided with a second example sentence generated from the first example sentence of the sentence ID D001 in the first example sentence data illustrated in FIG. 8. In this example, the target word, to which link data of “government” is added, is converted to a target word to which a tag indicating the label “ [symbol] ” (ORGANIZATION) is added.

The second record in the example of FIG. 16 is provided with a second example sentence generated from the first example sentence of the sentence ID D002 in the first example sentence data illustrated in FIG. 8. In this example, the target word, to which link data of “plant” is added, is converted to a target word to which a tag indicating the label “O” is added.

The third record in the example of FIG. 16 is provided with a second example sentence generated from the first example sentence of the sentence ID D003 in the first example sentence data illustrated in FIG. 8. In this example, the target word, to which link data of “plant” is added, is converted to a target word to which a tag indicating the label “O” is added.

The first generation unit 1401 may generate the second example sentence for some first example sentences among first example sentences included in the first example sentence data. Also, the first generation unit 1401 may add a second example sentence other than a second example sentence generated from the first example sentence, to the second example sentence data.

The second extraction unit 1405 identifies one of second example sentences stored in the second sentence storage unit 1403 (S1503). The second extraction unit 1405 extracts a label indicated by the tag from the identified second example sentence (S1505). The extracted label is set to a record of the second extracted data stored in the second extracted data storage unit 1407.

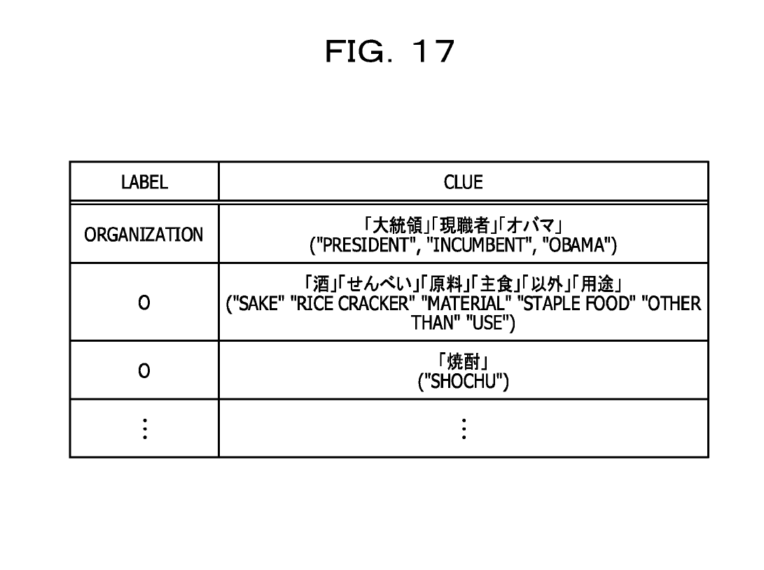

FIG. 17 illustrates an example of the second extracted data. The second extracted data includes a record corresponding to the second example sentence. The record of the second extracted data includes a field for setting the label indicated by a tag added to the target word contained in the second example sentence and a field for setting the clue word contained in the second example sentence. The clue word contained in the second example sentence is a noun other than the target word contained in the second example sentence.

In the first record in the example of FIG. 17, clue words “ [symbol] ” “ [symbol] ” and “ [symbol] ” extracted from the second example sentence of the sentence ID D001 are associated with the label “ [symbol] ” (ORGANIZATION) extracted from the tag added to the target word contained in the second example sentence of the sentence ID D001.

In the second record in the example of FIG. 17, clue words “ [symbol] ” “ [symbol] [symbol] ” “ [symbol] ” “ [symbol] ” “ [symbol] ” and “ [symbol] ” extracted from the second example sentence of the sentence ID D002 are associated with the label “O” extracted from the tag added to the target word contained in the second example sentence of the sentence ID D002.

In the third record in the example of FIG. 17, the clue word “ [symbol] ” extracted from the second example sentence of the sentence ID D003 is associated with the label “O” extracted from the tag added to the target word contained in the second example sentence of the sentence ID D003.

Description is continued by referring back to FIG. 15. The second extraction unit 1405 removes the tag indicating the label from the second example sentence identified in S1503 (S1507). The second extraction unit 1405 perform morphological analysis of the second example sentence from which the tag is removed (S1509). The second extraction unit 1405 extracts a word providing a clue for the meaning determination from the result of morphological analysis (S1511). The extracted clue word is set to the record of the second extracted data as described above.

The first determination unit 1409 determines the meaning of the target word contained in the second example sentence by applying the second extracted data to the meaning determiner generated in the first preprocessing (S1513). In this embodiment, the meaning determination processing in S1513 is referred to as the first determination processing.

Input of the meaning determiner corresponds to the clue in the second extracted data, and output thereof corresponds to the meaning in the second extracted data. The first determination unit 1409 calculates the second score for each meaning in accordance with the first rule data. Then, the first determination unit 1409 selects a meaning having a larger value of the second score. The selected meaning and the second score of the meaning are set to a record of the learning data stored in the learning data storage unit 1411.

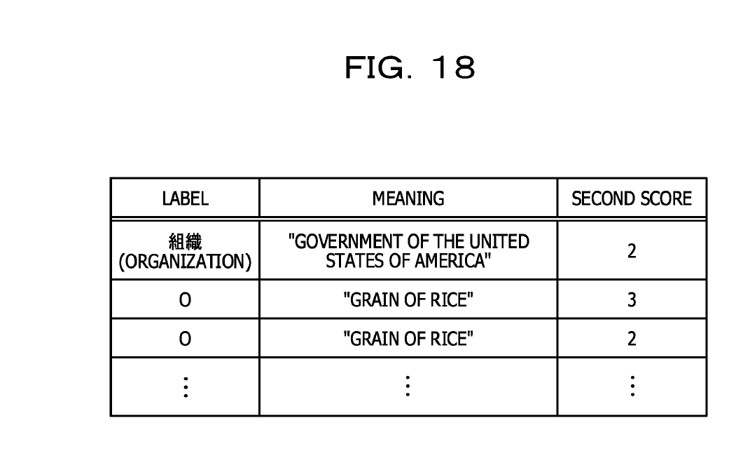

FIG. 18 illustrates an example of the learning data. The learning data includes a record corresponding to the second example sentence. One record corresponding to the second example sentence corresponds to one learning sample. Like the second extracted data described above, the record of the learning data includes a field for setting the label indicated by a tag added to the target word contained in the second example sentence. Further, the record of the learning data includes a field for setting the meaning determined by the meaning determiner, and a field for setting the second score obtained in determination of the meaning. The second score indicates a weight (accuracy of evaluation) relative to determination of the meaning.

In the first record in the example of FIG. 18, the meaning “government of The United States of America” determined based on the clue in the second example sentence and the second score “2” obtained in determination thereof are associated with the label “ [symbol] ” (ORGANIZATION) extracted from a tag added to the target word contained in the second example sentence of the sentence ID D001.

In the second record in the example of FIG. 18, the meaning “grain of rice” determined based on the clue in the second example sentence and the second score “3” obtained in determination thereof are associated with the label “O” extracted from a tag added to the target word contained in the second example sentence of the sentence ID D002.

In the third record in the example of FIG. 18, the meaning “grain of rice” determined based on the clue in the second example sentence and the second score “2” obtained in determination thereof are associated with the label “O” extracted from a tag added to the target word contained in the second example sentence of the sentence ID D003.

Description is continued by referring back to FIG. 15. After completing the first determination processing in S1513, the second extraction unit 1405 determines whether there is a second example sentence not yet processed (S1515). If determined that there is a second example sentence not yet processed, operation returns to the processing of S1503 and repeats the above processing.

Meanwhile, if determined that there is no second example sentence not yet processed, the second learning unit 1413 generates the label determiner based on the learning data stored in the learning data storage unit 1411 (S1517). However, the label determiner generated in this step is incomplete. The second learning unit 1413 performs machine learning, for example, by using a perceptron. In this embodiment, the processing of performing machine learning in S1517 is referred to as the second learning processing.

Input of the label determiner corresponds to the meaning in the learning data, and output thereof corresponds to the label in the learning data. Then, the learning data is given to a second network as sample data, and a third score indicating the coupling strength (may be referred to as coupled load) between the meaning and the label is determined by the error inverse propagation method. The second rule data including the third score is stored into the second rule storage unit 315. The label determiner at this stage includes second rule data. The second learning unit 1413 may learn by using the second score as the importance of the learning sample.

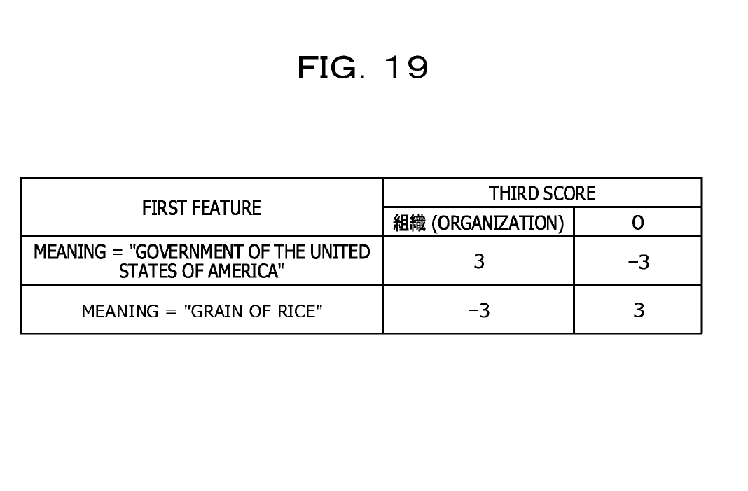

FIG. 19 illustrates an example of the second rule data. The second rule data includes a record for each of first features defining the meaning of the target word. The first feature corresponds to the rule for determining the label of the target word. The record of the second rule data includes a field for setting the first feature and a field for setting the third score for each label.

The third score indicates the relation between the first feature and the label. A positive third score to the combination of the first feature and the label indicates that when the meaning of the target word contained in a sentence matches the first feature, selection of the label with respect to the target word is affirmative. A negative third score to the combination of the first feature and the label indicates that when the meaning of the target word contained in a sentence matches the first feature, selection of the label with respect to the target word is negative. The absolute value of the third score indicates the strength of the relation between the first feature (that is, meaning) and the label.

The first record in the example of FIG. 19 indicates that the third score “3” is assigned to the combination of the first feature indicating that the meaning of the target word is “government of The United States of America”, and the label “ [symbol] ” (ORGANIZATION). Further, the record in the example of FIG. 19 indicates that the third score “−3” is assigned to the combination of the first feature indicating that the meaning of the target word is “government of The United States of America”, and the label “O”. That is, the first record in the example of FIG. 19 indicates a tendency that in a sentence in which the target word meaning “government of The United States of America” is used, the label “ [symbol] ” (ORGANIZATION) has to be selected for the target word, but not the label “O”.

The second record in the example of FIG. 19 indicates that the third score “−3” is assigned to the combination of the first feature indicating that the meaning of the target word is “grain of rice”, and the label “ [symbol] ” (ORGANIZATION). Further, the second record in the example of FIG. 19 indicates that the third score “3” is assigned to the combination of the first feature indicating that the meaning of the target word is “grain of rice”, and the label “O”. That is, the second record in the example of FIG. 19 indicates a tendency that in a sentence in which the target word meaning “grain of rice” is used, the label “O” has to be assigned to the target word, but not the label “ [symbol] ” (ORGANIZATION).

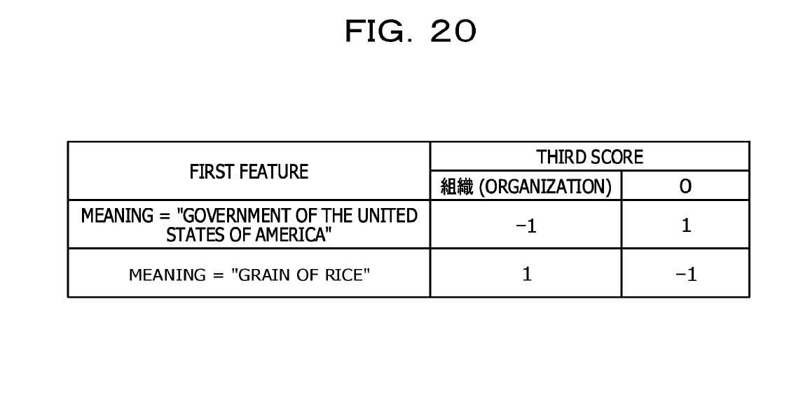

FIG. 20 illustrates an example of another second rule data. The second rule data in the example of FIG. 20 indicates, on the contrary to the case of FIG. 19, a tendency that in a sentence in which the target word meaning “government of The United States of America” is used, the label “O” has to be selected for the target word, but not the label “ [symbol] ” (ORGANIZATION). Further, the second rule data in the example of FIG. 20 indicates a tendency that in a sentence in which the target word meaning “grain of rice” is used, the label “ [symbol] ” (ORGANIZATION) is to be assigned to the target word, but not the label “O”. Such second rule data is not appropriate for proper determination of the label. Such second rule data may be generated when a context in the second example sentence is contrary to a context in the first example sentence. However, if the second example sentence is generated from the first example sentence as in this embodiment, a context in the second example sentence matches a context of the first example sentence. Therefore inappropriate second rule data such as illustrated in FIG. 20 is unlikely to be generated.

After completion of the second learning processing in S1517 illustrated in FIG. 15, operation shifts to S407 illustrated in FIG. 4.

Description is continued by referring back to FIG. 4. The main processing unit 317 executes a main processing (S407). The main processing unit 317 performs, in the main processing, second machine learning for generating a label determiner based on a third example sentence stored in the third sentence storage unit 2103, first rule data stored in the first rule storage unit 311, and second rule data stored in the second rule storage unit 315. Third rule data obtained by the second machine learning is stored into the third rule storage unit 319.

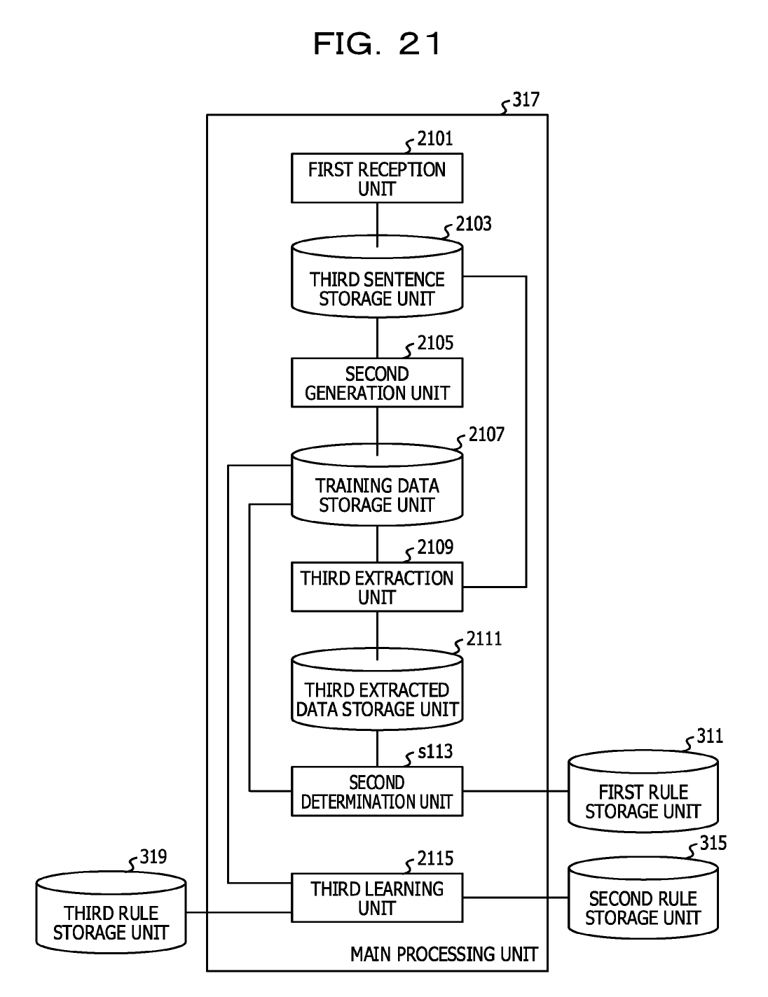

FIG. 21 illustrates a module configuration example of the main processing unit 317. The main processing unit 317 includes a first reception unit 2101, a third sentence storage unit 2103, a second generation unit 2105, a training data storage unit 2107, a third extraction unit 2109, a third extracted data storage unit 2111, a second determination unit 2113, and a third learning unit 2115.

The first reception unit 2101 receives a third example sentence containing the target word to which a tag indicating the label is added. The third sentence storage unit 2103 stores the third example sentence data. The second generation unit 2105 generates a second feature related to the target word contained in the third example sentence and a word connected to the target word. The training data storage unit 2107 stores training data. The third extraction unit 2109 extracts a word providing a clue for the meaning determination from a plurality of third example sentences. The third extracted data storage unit 2111 stores third extracted data covering all words providing a clue for the meaning determination. The second determination unit 2113 determines the meaning of the target word contained in the third example sentence based on third extracted data in accordance with the first rule data. The third learning unit 2115 learns third rule data identifying the label based on a second feature based on the third example sentence, a third feature related to the meaning in the third example sentence, a label in the third example sentence, and second rule data. The third rule data is generated based on the second rule data. The data and processing described above are described in detail below.

The first reception unit 2101, the second generation unit 2105, the third extraction unit 2109, the second determination unit 2113, and the third learning unit 2115 are implemented by using a hardware resource (for example, FIG. 42) and a program which causes a processor to execute the processings described below.

The third sentence storage unit 2103, the training data storage unit 2107, and the third extracted data storage unit 2111 are implemented by using a hardware resource (for example, FIG. 42).

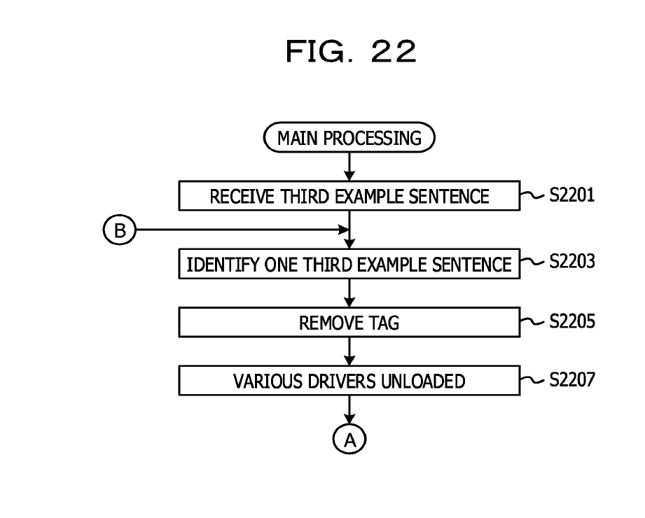

FIG. 22 illustrates an example of a main processing flow. The first reception unit 2101 receives the third example sentence, for example, via a storage medium or a communication medium (S2201). The received third example sentence is stored into the third sentence storage unit 2103. By using, as a third example sentence, a sentence which includes a context supposed to approximate a sentence whose label is desired to be automatically determined (hereinafter referred to as application target sentence), improvement of the label determination accuracy is expected. For example, a suitable learning result could be obtained if a sentence in the same field as the application target sentence is used as the third example sentence, or if a sentence of the same author as the application target sentence is used as the third example sentence.

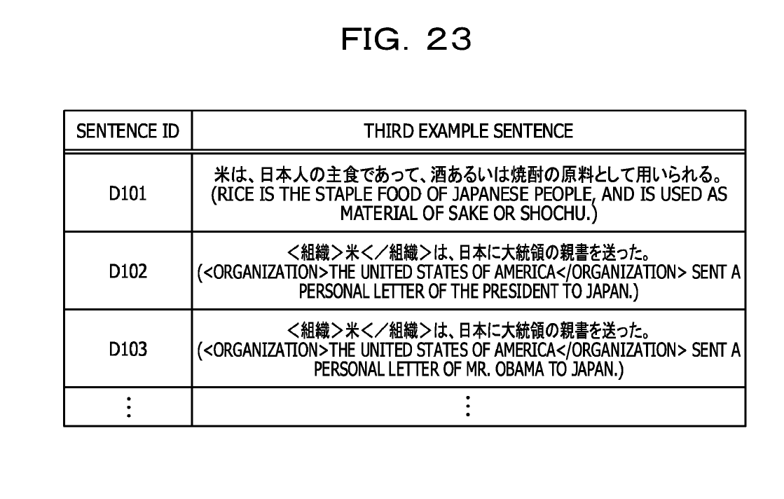

FIG. 23 illustrates an example of third example sentence data. The third example sentence data is provided with a record for each of third example sentences. The record stores a third example sentence associated with the sentence ID.

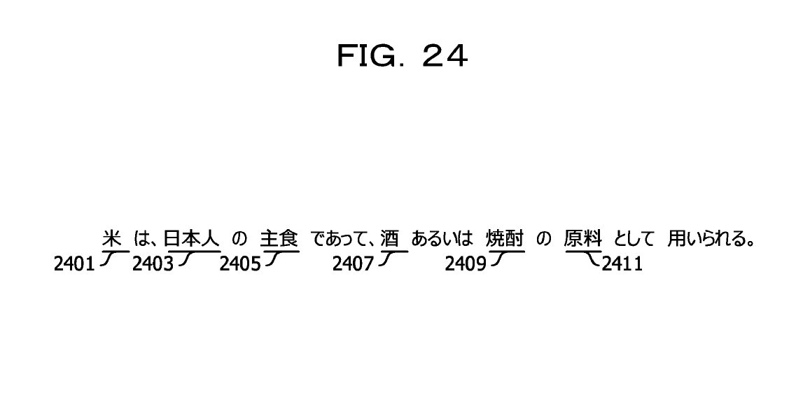

First, a third example sentence of the sentence ID D101 “ [symbol] [symbol] [symbol] [symbol] [symbol] [symbol] ” (Rice is the staple food of Japanese people and is used as a material of sake or shochu) in the third example sentence data illustrated in FIG. 23 is described with reference to FIG. 24.

The third example sentence of the sentence ID D101 contains six nouns including a first noun 2401, a second noun 2403, a third noun 2405, a fourth noun 2407, a fifth noun 2409, and a sixth noun 2411. Among those nouns, the first noun 2401 is the target word. The first noun 2401 in this example is used to mean “grain of rice”. That is, the first noun 2401 does not fall under the unique expression. In this example, when the noun does not fall under the unique expression, a tag indicating the label is not added thereto. However, when the noun does not fall under the unique expression, tags <O> and </O> indicating that the noun does not fall under the type of unique expression may be added thereto.

The second noun 2403 is “ [symbol] ” expressed with three Chinese characters as illustrated. The third noun 2405 is “ [symbol] ” expressed with two Chinese characters as illustrated. The fourth noun 2407 is “ [symbol] ” expressed with one Chinese character as illustrated. The fifth noun 2409 is “ [symbol] ” expressed with two Chinese characters as illustrated. The sixth noun 2411 is “ [symbol] ” expressed with two Chinese characters as illustrated.

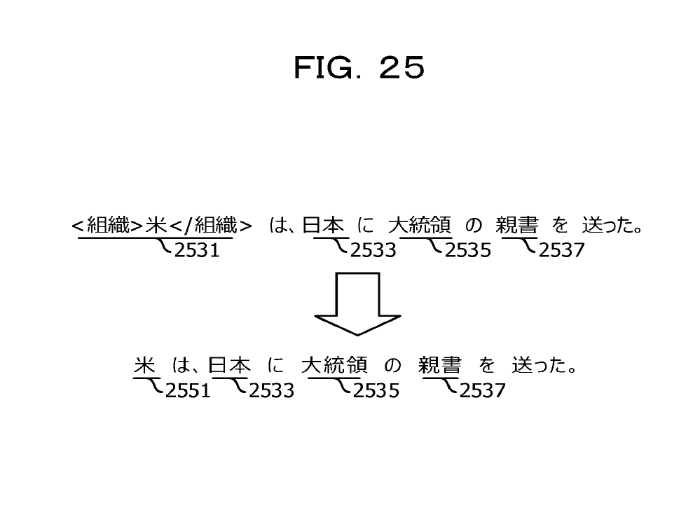

Next, the third example sentence of the sentence ID D102 “< [symbol] > [symbol] < [symbol] > sent a personal letter of the president to Japan” in the third example sentence data illustrated in FIG. 23 is described with reference to FIG. 25.

The third example sentence of the sentence ID D102 contains four nouns including a first noun 2531, a second noun 2533, a third noun 2535, and a fourth noun 2537. Among those nouns, the first noun 2531 is the target word. The first noun 2531 in this example is used to mean “government of The United States of America”. That is, the first noun 2531 falls under the unique expression. If the noun falls under the unique expression, a tag indicating the label (in this example, type of unique expression) is added. In this example, a tag indicating the type of unique expression “ORGANIZATION” is added to one Chinese character of the first noun 2531. However, format of the data indicating the label is not limited to the tag illustrated in this example. Data indicating the label in the third example sentence may be of a format different from data indicating the label in the second example sentence.

The lower part of FIG. 25 illustrates a third example sentence with the tag removed. The first noun 2551 is normally expressed with the tag removed from the first noun 2531 illustrated in the upper part. The second noun 2533, the third noun 2535 and the fourth noun 2537 are the same as in the upper part.

In this example, except for the first noun 2551 which corresponds to the target word, the second noun 2533, the third noun 2535 and the fourth noun 2537 are extracted as words providing a clue for the meaning determination.

The second noun 2533 is “ [symbol] ” expressed with two Chinese characters as illustrated. The third noun 2535 is “ [symbol] ” expressed with three Chinese characters as illustrated. The fourth noun 2537 is “ [symbol] ” expressed with two Chinese characters as illustrated.

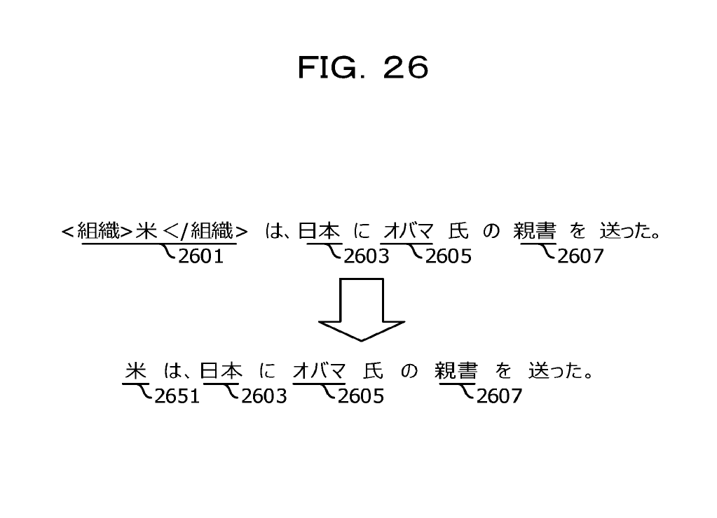

Finally, the third example sentence of the sentence ID D103 “ [symbol] [symbol] > [symbol] </ [symbol] [symbol] [symbol] ” (“<ORGANIZATION>rice</ORGANIZATION> sent a personal letter of Mr. Obama to Japan.”) in the third example sentence data illustrated in FIG. 23 is described with reference to FIG. 26.

The third example sentence of the sentence ID D103 contains four nouns including a first noun 2601, a second noun 2603, a third noun 2605, and a fourth noun 2607. Among those nouns, the first noun 2601 is the target word. The first noun 2601 in this example is used to mean “government of The United States of America”. That is, the first noun 2601 falls under the unique expression. In this example, like in FIG. 25, a tag indicating the type of unique expression “ [symbol] ” (ORGANIZATION) is added to one Chinese character of the first noun 2601.

The lower part of FIG. 26 illustrates a third example sentence with the tag removed. The first noun 2651 is normally expressed with the tag removed from the first noun 2601 illustrated in the upper part. The second noun 2603, the third noun 2605 and the fourth noun 2607 are the same as in the upper part.

In this example, except for the first noun 2651 which corresponds to the target word, the second noun 2603, the third noun 2605 and the fourth noun 2607 are extracted as words providing a clue for the meaning determination.

The second noun 2603 is “ [symbol] ” expressed with two Chinese characters as illustrated. The third noun 2605 is “ [symbol] ” expressed with three katakana as illustrated. The fourth noun 2607 is “ [symbol] ” expressed with two Chinese characters as illustrated. Now, description of the third example sentence ends.

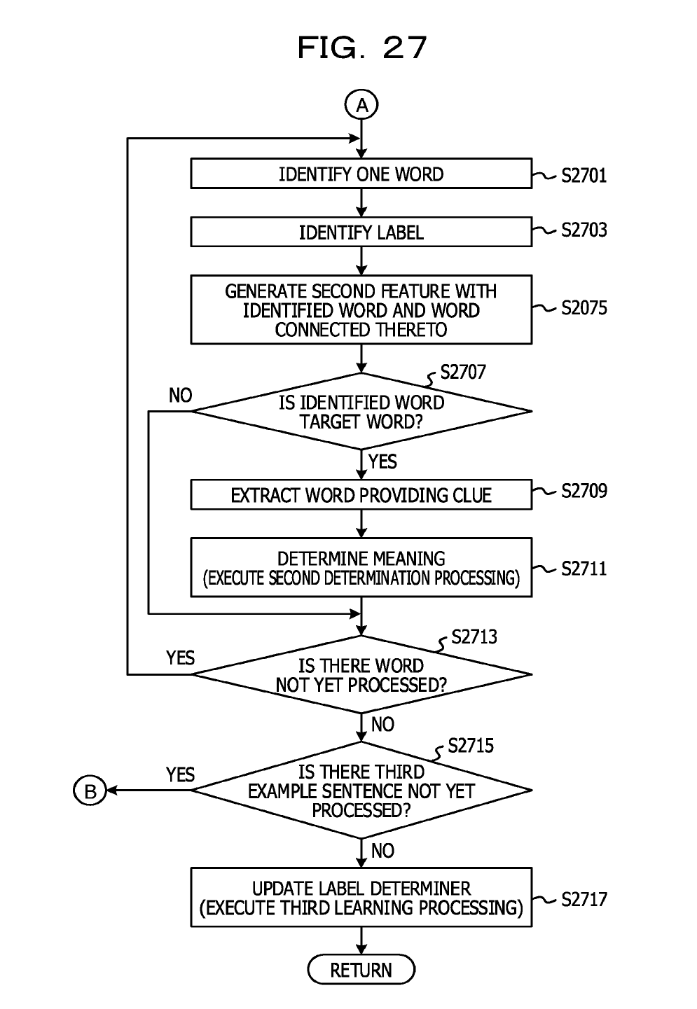

Description is continued by referring back to FIG. 22. The second generation unit 2105 identifies one of third example sentences stored in the third sentence storage unit 2103 (S2203). The second generation unit 2105 removes the tag indicating the label from the identified third example sentence (S2205). The second generation unit 2105 performs morphological analysis of the third example sentence from which the tag is removed (52207). After completion of the morphological analysis, operation shifts to S2701 illustrated in FIG. 27 via a terminal A.

The second generation unit 2105 identifies one word from the result of the morphological analysis (S2701). For example, the second generation unit 2105 identifies one word in the order of appearance. The second generation unit 2105 identifies the label for the identified word (S2703). Specifically, for the word to which a tag is added, the label indicated by the tag is identified. For the word to which a tag is not added, the label “O” is assigned. The identified label is set into a training data stored in the training data storage unit 2107.

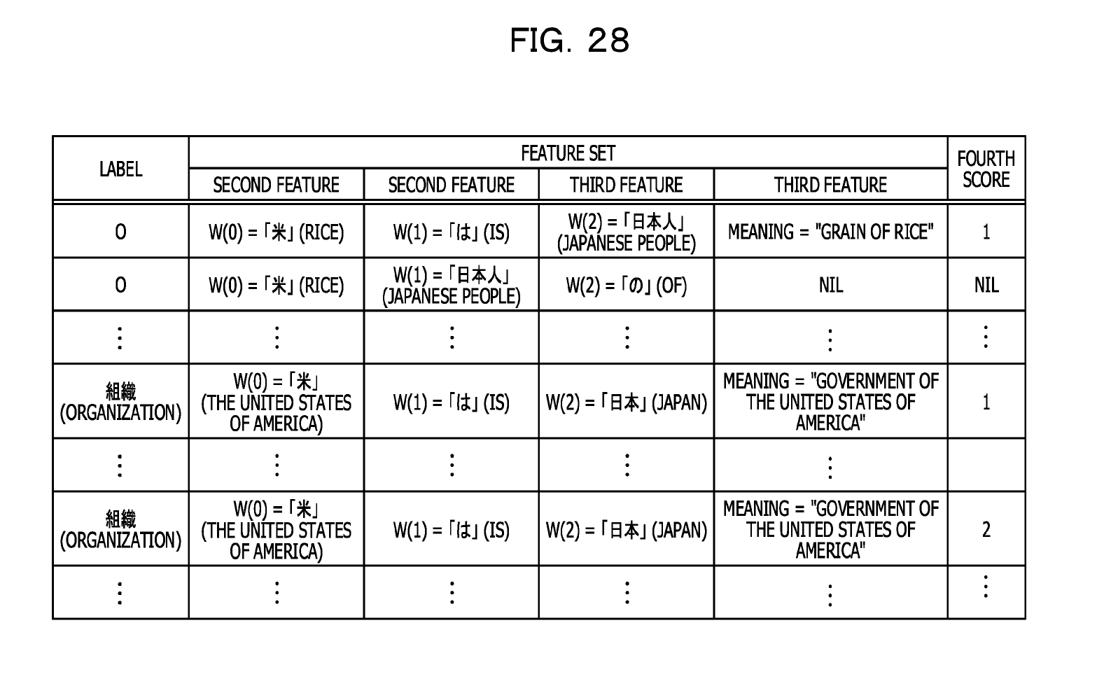

FIG. 28 illustrates an example of the training data. The training data includes a record corresponding to each word of the third example sentence. In this example, the record of the training data includes a field for setting the label of the focused word, a field for setting three second features, a field for setting the third feature, and a field for setting the fourth score.

The second feature is a feature which identifies the focused word and a word connected thereto. In the example of FIG. 28, W(0) means the focused word. Similarly, W(1) means a word next to the focused word. Similarly, W(2) means a second next word following the focused word. A second feature for identifying a third or subsequent word may be used. Also, a second feature for identifying a last word W(−1) preceding the focused word, a second feature for identifying a second last word W(−2) preceding the focused word, or a second feature for identifying a third or more previous last word preceding the focused word may be used. Also, a second feature for identifying the focused word W(0) may be omitted.

The third feature is a feature for identifying the meaning of the focused word W(0). However, when the focused word W(0) is not the target word, the third feature is not set.

Thus, in the example of FIG. 28, a feature set comprising three second features and a third feature is set.

The fourth score is a score assigned when determining the meaning of the focused word. The fourth score indicates a weight (accuracy of evaluation) relative to determination of the meaning. That is, the fourth score is a value of the same type as the second score described above.

The first record in the example of FIG. 28 is a record corresponding to a first word in the third example sentence of the sentence ID D101. That is, in this record, a first word in the third example sentence of the sentence ID D101 is focused. The label “O” set to the first record in the example of FIG. 28 indicates that a label indicating the type of the proper noun is not assigned to the first word in the third example sentence of the sentence ID D101. In the first record in the example of FIG. 28, a second feature indicating that the focused word W(0) matches a first word in the third example sentence of the sentence ID D101, a second feature indicating that a word W(1) next to the focused word matches a second word in the third example sentence of the sentence ID D101, and a second feature indicating that a second next word W(2) following the focused word matches a third word in the third example sentence of the sentence ID D101 are set. Further, in the first record in the example of FIG. 28, a third feature indicating that the meaning of the focused word W(0) is “grain of rice”, and a fourth score “1” obtained when determining the meaning “grain of rice” of the focused word W(0) are set.

The second record in the example of FIG. 28 is a record corresponding to a second word in the third example sentence of the sentence ID D101. That is, in this record, a second word in the third example sentence of the sentence ID D101 is focused. The label “O” set to the second record in the example of FIG. 28 indicates that a label indicating the type of the proper noun is not assigned to the second word in the third example sentence of the sentence ID D101. In the second record in the example of FIG. 28, a second feature indicating that the focused word W(0) matches a second word in the third example sentence of the sentence ID D101, a second feature indicating that a word W(1) next to the focused word matches a third word in the third example sentence of the sentence ID D101, and a second feature indicating that a second next word W(2) following the focused word matches a fourth word in the third example sentence of the sentence ID D101 are set. Since a second word in the third example sentence of the sentence ID D101 is not the target word, the third feature and the fourth score are not set.

Description of records corresponding to third and subsequent words in the third example sentence of the sentence ID D101 is omitted.

The third record in the example of FIG. 28 is a record corresponding to a first word in the third example sentence of the sentence ID D102. That is, in this record, a first word in the third example sentence of the sentence ID D102 is focused. The third record in the example of FIG. 28 indicates that a label indicating the type of the proper noun “ [symbol] ” (ORGANIZATION) is assigned to a first word in the third example sentence of the sentence ID D102. In the third record in the example of FIG. 28, a second feature indicating that the focused word W(0) matches a first word in the third example sentence of the sentence ID D102, a second feature indicating that a word W(1) next to the focused word matches a second word in the third example sentence of the sentence ID D102, and a second feature indicating that a second next word W(2) following the focused word matches a third word in the third example sentence of the sentence ID D102 are set. Further, in the third record in the example of FIG. 28, a third feature indicating that the meaning of the focused word W(0) is “government of The United States of America”, and a fourth score “1” obtained when determining the meaning “government of The United States of America” of the focused word W(0) are set.

Description of records corresponding to second and subsequent words in the third example sentence of the sentence ID D102 is omitted.

The fourth record in the example of FIG. 28 is a record corresponding to a first word in the third example sentence of the sentence ID D103. That is, in this record, a first word in the third example sentence of the sentence ID D103 is focused. The fourth record in the example of FIG. 28 indicates that a label indicating the type of the proper noun “ [symbol] ” (ORGANIZATION) is assigned to a first word in the third example sentence of the sentence ID D103. In the fourth record in the example of FIG. 28, a second feature indicating that the focused word W(0) matches a first word in the third example sentence of the sentence ID D103, a second feature indicating that a word W(1) next to the focused word matches a second word in the third example sentence of the sentence ID D103, and a second feature indicating that a second next word W(2) following the focused word matches a third word in the third example sentence of the sentence ID D103 are set. Further, in the fourth record in the example of FIG. 28, a third feature indicating that the meaning of the focused word W(0) is “government of The United States of America”, and a fourth score “2” obtained when determining the meaning “government of The United States of America” of the focused word W(0) are set.

Description of records corresponding to second and subsequent words in the third example sentence of the sentence ID D103 is omitted.

Description is continued by referring back to FIG. 27. The second generation unit 2105 generates a second feature which identifies the identified word and a word connected thereto (S2705). As described above, the second feature is determined by the positional relation with respect to the focused word and the association with the word itself at the position.

The third extraction unit 2109 determines whether the word identified in S2701 is the target word (S2707). When determined that the word identified in S2701 is not the target word, the meaning determination is not performed, and operation shifts directly to S2713.

When determined that the word identified in S2701 is the target word, the third extraction unit 2109 extracts a word providing a clue for the meaning determination from results of the morphological analysis (S2709). The clue word contained in the third example sentence is a noun other than the target word contained in the third example sentence. The clue word is set into a record of the third extracted data stored in the third extracted data storage unit 2111.

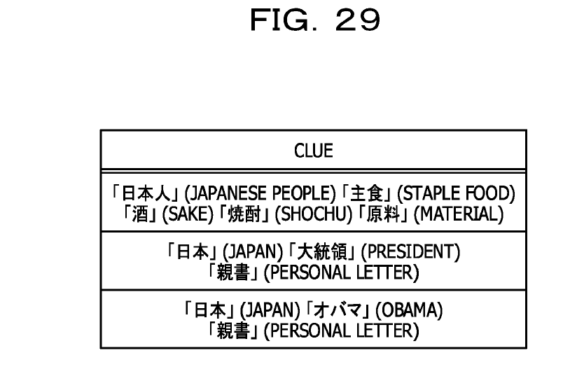

FIG. 29 illustrates an example of the third extracted data. The third extracted data includes a record corresponding to the third example sentence. A record of the third extracted data includes a field for setting the clue word contained in the third example sentence.

In the first record in the example of FIG. 29, clue words “ [symbol] ” “ [symbol] ” “ [symbol] ” “ [symbol] ” and “ [symbol] ” extracted from the third example sentence of the sentence ID D101 are set.

In the second record in the example of FIG. 29, clue words “ [symbol] ” “ [symbol] ” and “ [symbol] ” extracted from the third example sentence of the sentence ID D102 are set.

In the third record in the example of FIG. 29, clue words “ [symbol] [symbol] ” and “ [symbol] ” extracted from the third example sentence of the sentence ID D103 are set.

Description is continued by referring back to FIG. 27. The second determination unit 2113 determines the meaning of the target word contained in the third example sentence identified in S2203, by applying the third extracted data to the meaning determiner generated in the first preprocessing (S2711). In this embodiment, the meaning determination processing in S2711 is referred to as the second determination processing.

Input of the meaning determiner corresponds to the clue in the third extracted data, and output thereof corresponds to the meaning in the third extracted data. The second determination unit 2113 calculates a fourth score for each meaning in accordance with the first rule data. The fourth score corresponds to the evaluation value for the meaning. Then, the second determination unit 2113 selects a meaning having a larger value of the fourth score. The selected meaning is set into a record of the training data stored in the training data storage unit 2107 as the third feature. The fourth score of the selected meaning are also set to a record of the training data stored in the training data storage unit 2107.

Description is continued by referring back to FIG. 27. The second generation unit 2105 determines whether there is a word not yet processed (S2713). If determined that there is a word not yet processed, operation returns to S2701 and repeats the above processing.

Meanwhile, if determined that there is no word not yet processed, the second generation unit 2105 determines whether there is a third example sentence not yet processed (S2715). If determined that there is a third example sentence not yet processed, operation returns to the processing of S2203 illustrated in FIG. 22 and repeats the above processing via a terminal B.

Meanwhile, when determined that there is no third example sentence not yet processed, the third learning unit 2115 updates the label determiner generated in the second learning processing of S1517 of FIG. 15 (S2717). Then, the third learning unit 2115 performs machine learning, for example, by using a perceptron. In this embodiment, the processing of performing machine learning in S2717 is referred to as the third learning processing.

Input of the label determiner corresponds to the feature set in the training data (in this example, three second features and a third feature), and output thereof corresponds to the label in the training data. The second rule data obtained in the second learning processing is used as a default value. Specifically, the third learning unit 2115 sets a third score pertaining to the combination of the first feature and label in the second rule data to the coupling strength of the third feature and the label. Then, with the training data as a sample data, a fifth score indicating the coupling strength of features and labels contained in the feature set is determined. The third rule data including the fifth score is stored in the third rule storage unit 319. In this example, the finished label determiner includes third rule data. The third learning unit 2115 may learn by using the fourth score as the importance of the teacher sample related to the third feature.

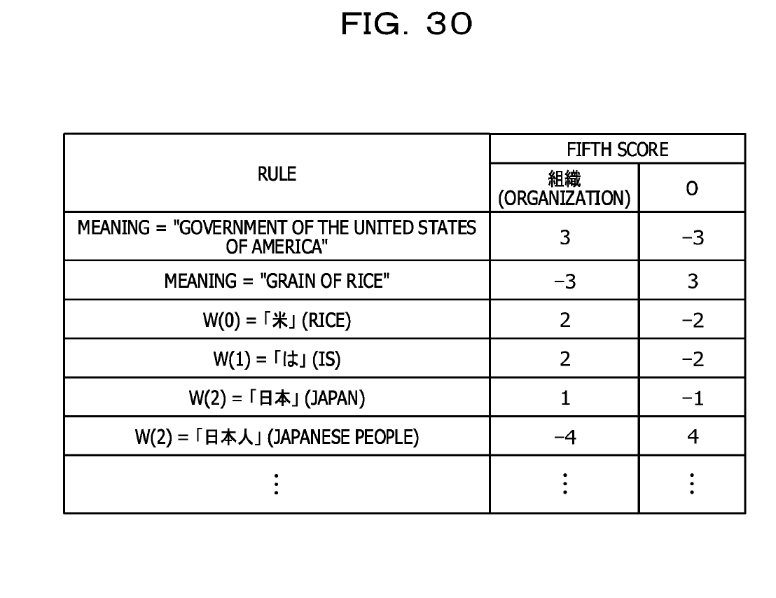

FIG. 30 illustrates an example of the third rule data. The third rule data includes a record for each of rules for determining the label of the target word. The rule for determining the label of the target word corresponds to a feature included in the feature set of the training data illustrated in FIG. 28, that is, the second feature or the third feature. The record of the third rule data includes a field for setting a rule for determining the label of the target word, and a field for setting the fifth score for each label of the target word.

The fifth score indicates the relation between the rule and the label. A positive fifth score to the combination of the rule and the label indicates that when the target word contained in a sentence matches the rule, selection of the label for the target word in the sentence is affirmative. A negative fifth score to the combination of the rule and the label indicates that when the target word contained in a sentence matches the rule, selection of the label for the target word in the sentence is negative. The absolute value of the fifth score indicates the strength of the relation between the rule and the label.

The first record in the example of FIG. 30 indicates that the fifth score “3” is assigned to the combination of the rule indicating that the meaning of the target word is “government of The United States of America”, and the label “ [symbol] ” (ORGANIZATION). Further, the first record in the example of FIG. 30 indicates that the fifth score “−3” is assigned to the combination of the rule indicating that the meaning of the target word is “government of The United States of America”, and the label “O”. That is, the first record in the example of FIG. 30 indicates a tendency that in a sentence in which the target word meaning “government of The United States of America” is used, the label “ [symbol] ” (ORGANIZATION) is to be selected for the target word, but the label “O” is not to be selected.

The second record in the example of FIG. 30 indicates that the fifth score “−3” is assigned to the combination of the rule indicating that the meaning of the target word is “grain of rice”, and the label “ [symbol] ” (ORGANIZATION). Further, the second record in the example of FIG. 30 indicates that the fifth score “3” is assigned to the combination of the rule indicating that the meaning of the target word is “grain of rice”, and the label “ [symbol] ”. That is, the second record in the example of FIG. 30 indicates a tendency that in a sentence in which the target word meaning “grain of rice” is used, the label “ [symbol] ” is to be selected for the target word, but the label “ [symbol] ” (ORGANIZATION) is not to be selected.

The rule of the third record in the example of FIG. 30 corresponds, for example, to the first second feature in the first record illustrated in FIG. 28. The third record in the example of FIG. 30 indicates that the fifth score “2” is assigned to the combination of the rule and the label “ [symbol] ” (ORGANIZATION). Further, the third record in the example of FIG. 30 indicates that the fifth score “−2” is assigned to the combination of the rule and the label “ [symbol] ”. That is, the third record in the example of FIG. 30 indicates a tendency that when the focused word W(0) matches, for example, the noun “ [symbol] ” of one Chinese character illustrated as the first noun 2401 in FIG. 24, the label “ [symbol] ” (ORGANIZATION) is to be selected for the target word, but the label “ [symbol] ” is not to be selected.

The rule of the fourth record in the example of FIG. 30 corresponds, for example, to the second feature in the first record illustrated in FIG. 28. The fourth record in the example of FIG. 30 indicates that the fifth score “2” is assigned to the combination of the rule and the label “ [symbol] ” (ORGANIZATION). Further, the fourth record in the example of FIG. 30 indicates that the fifth score “−2” is assigned to the combination of the rule and the label “ [symbol] ”. That is, the fourth record in the example of FIG. 30 indicates a tendency that when the word W(1) next to the focused word matches, for example, a particle of one hiragana character indicated in the second row in FIG. 24, the label “ [symbol] ” (ORGANIZATION) is to be selected for the target word, but the label “ [symbol] ” is not to be selected.

The rule of the fifth record in the example of FIG. 30 corresponds, for example, to the third second feature in the third record illustrated in FIG. 28. The fifth record in the example of FIG. 30 indicates that the fifth score “1” is assigned to the combination of the rule and the label “ [symbol] ” (ORGANIZATION). Further, the fifth record in the example of FIG. 30 indicates that the fifth score “−1” is assigned to the combination of the rule and the label “ [symbol] ”. That is, the fifth record in the example of FIG. 30 indicates a tendency that when a second next word W(2) following the focused word matches, for example, the noun “ [symbol] ” of two Chinese characters illustrated as the second noun 2533 in FIG. 25, the label “ [symbol] ” (ORGANIZATION) is to be selected for the target word, but the label “O” is not to be selected.

The rule of the sixth record in the example of FIG. 30 corresponds, for example, to the third second feature in the first record illustrated in FIG. 28. The sixth record in the example of FIG. 30 indicates that the fifth score “−4” is assigned to the combination of the rule and the label “ [symbol] ” (ORGANIZATION). Further, the sixth record in the example of FIG. 30 indicates that the fifth score “4” is assigned to the combination of the rule and the label “O”. That is, the sixth record in the example of FIG. 30 indicates a tendency that when the second next word W(2) following the focused word matches, for example, the noun “ [symbol] [symbol] ” of three Chinese characters illustrated as the second noun 2403 in FIG. 24, the label “ [symbol] ” is to be selected for the target word, but the label “ [symbol] ” (ORGANIZATION) is not to be selected.

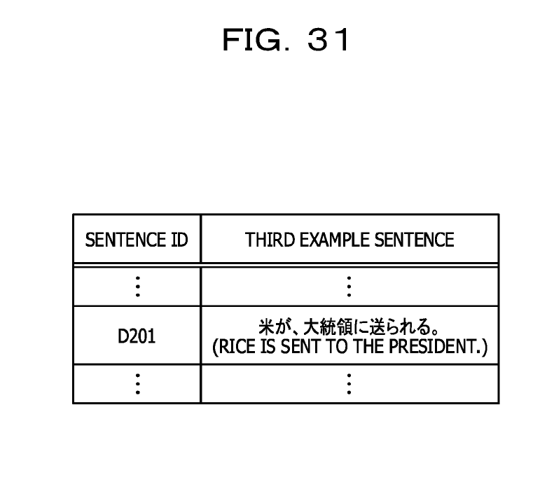

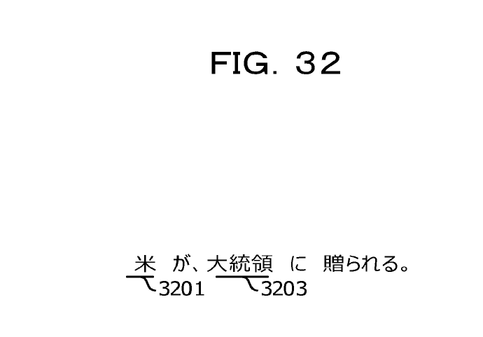

Here, FIG. 31 illustrates another example of the third example sentence data. The third example sentence “ [symbol] [symbol] ” (rice is sent to the president) of the sentence ID D201 in the third example sentence data illustrated in FIG. 31 is described with reference to FIG. 32.

The third example sentence of the sentence ID D201 contains two nouns including a first noun 3201 and a second noun 3203. Among those nouns, the first noun 3201 is the target word. The first noun 3201 in this example is used to mean “grain of rice”. That is, the first noun 3201 does not fall under the unique expression. Therefore, a tag indicating the label is not added.

The second noun 3203 is “ [symbol] ” expressed with three Chinese characters as illustrated.

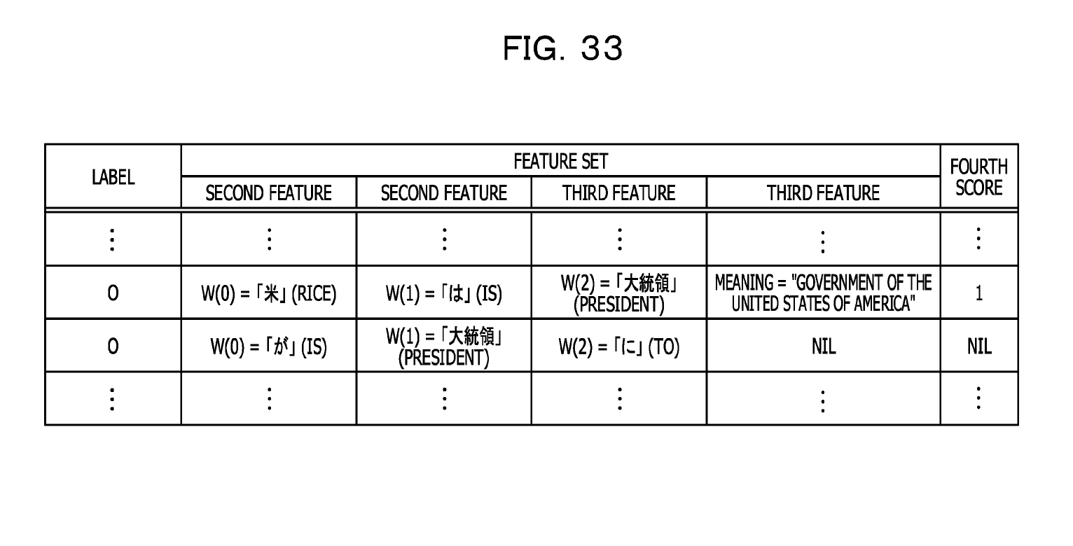

FIG. 33 illustrates an example of training data generated based on the third example sentence of the sentence ID D201 illustrated in FIG. 31. The first record in the example of FIG. 33 is a record corresponding to the first word in the third example sentence of the sentence ID D201. That is, in this record, the first word in the third example sentence of the sentence ID D201 is focused. The label “O” set to the first record in the example of FIG. 33 indicates that a label indicating the type of the proper noun is not assigned to the first word in the third example sentence of the sentence ID D201. In the first record in the example of FIG. 33, a second feature indicating that the focused word W(0) matches a first word in the third example sentence of the sentence ID D201, a second feature indicating that a word W(1) next to the focused word matches a second word in the third example sentence of the sentence ID D201, and a second feature indicating that the second next word W(2) following the focused word matches a third word in the third example sentence of the sentence ID D201 are set.

Further, in the first record in the example of FIG. 33, a third feature indicating that the meaning of the focused word W(0) is “government of The United States of America”, and a fourth score “1” obtained when determining the meaning “government of The United States of America” of the focused word W(0) are set.

In the first record in the example of FIG. 33, the label (“O”) and the third feature (meaning=“government of The United States of America”) do not match in terms of content. When the context in the third example sentence is contrary to the context in the first example sentence which is the basis for generating the meaning determiner, training data including erroneous meaning determination results may be generated like examples described above with reference to FIGS. 31 to 33. Then, when the amount of training data is not sufficient, the meaning is likely to be affected by an erroneous meaning determination result. Therefore, it is difficult to learn ideal rule data for correctly determining the meaning even when an erroneous meaning determination result is given. However, in this embodiment, learning is performed with training data based on the second rule data (FIG. 19) obtained from automatically generated numerous learning data. Therefore, the meaning is unlikely to be affected by the erroneous meaning determination result.

The second record in the example of FIG. 33 is a record corresponding to the second word in the third example sentence of the sentence ID D201. Here, description of the second record is omitted.

As illustrated in FIG. 4, when the main processing in S407 ends, processing of the learning apparatus 301 also ends. Now, description of the learning apparatus 301 ends.

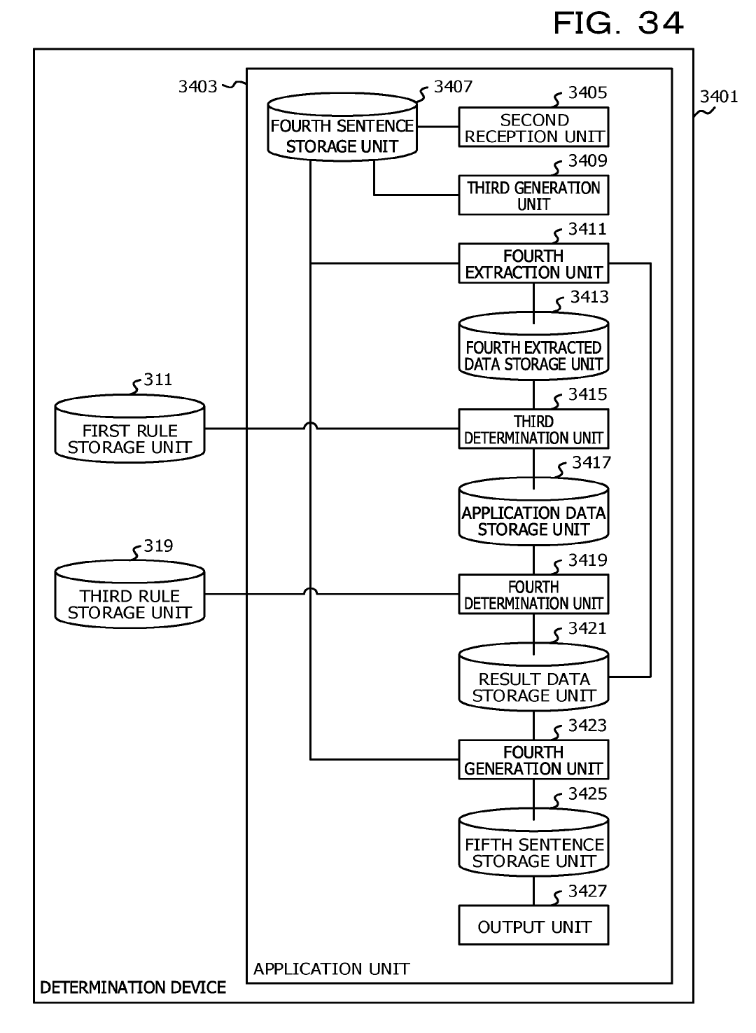

Next, the determination device is described. The determination device is a computer which automatically determines the label of the target word contained in the application target sentence. FIG. 34 illustrates a module configuration example of the determination device 3401. The determination device 3401 includes a first rule storage unit 311, a third rule storage unit 319, and an application unit 3403.

The first rule storage unit 311 stores first rule data generated by the learning apparatus 301. The third rule storage unit 319 stores third rule data generated by the learning apparatus 301.

The application unit 3403 includes a second reception unit 3405, a fourth sentence storage unit 3407, a third generation unit 3409, a fourth extraction unit 3411, a fourth extracted data storage unit 3413, a third determination unit 3415, an application data storage unit 3417, a fourth determination unit 3419, a result data storage unit 3421, a fourth generation unit 3423, a fifth sentence storage unit 3425, and an output unit 3427.

The application unit 3403 applies the label determiner to the application target sentence. The second reception unit 3405 receives the application target sentence containing the target word. The fourth sentence storage unit 3407 stores the application target sentence. The third generation unit 3409 generates the fourth feature related to the target word contained in the application target sentence or a word connected to the target word. The fourth extraction unit 3411 extracts a word providing a clue for the meaning determination from the application target sentence. The fourth extracted data storage unit 3413 stores fourth extracted data covering all words providing a clue for the meaning determination. The third determination unit 3415 determines the meaning of the target word contained in the application target sentence based on the fourth extracted data in accordance with the first rule data. The application data storage unit 3417 stores application data based on the application target sentence. The fourth determination unit 3419 determines the label of the target word contained in the application target sentence based on the application data in accordance with the third rule data. The result data storage unit 3421 stores result data including the determined label. The fourth generation unit 3423 generates the output sentence by adding the label to the application target sentence. The fifth sentence storage unit 3425 stores the output sentence. The output unit 3427 outputs the output sentence. The data and processing described above are described in detail below.

The determination device 3401, the application unit 3403, the second reception unit 3405, the third generation unit 3409, the fourth extraction unit 3411, the third determination unit 3415, the fourth determination unit 3419, the fourth generation unit 3423, and the output unit 3427 are implemented by using a hardware resource (for example, FIG. 42) and a program which causes a processor to execute the processings described below.

The first rule storage unit 311, the third rule storage unit 319, the fourth sentence storage unit 3407, the fourth extracted data storage unit 3413, the application data storage unit 3417, the result data storage unit 3421, and the fifth sentence storage unit 3425 are implemented by using a hardware resource (for example, FIG. 42).

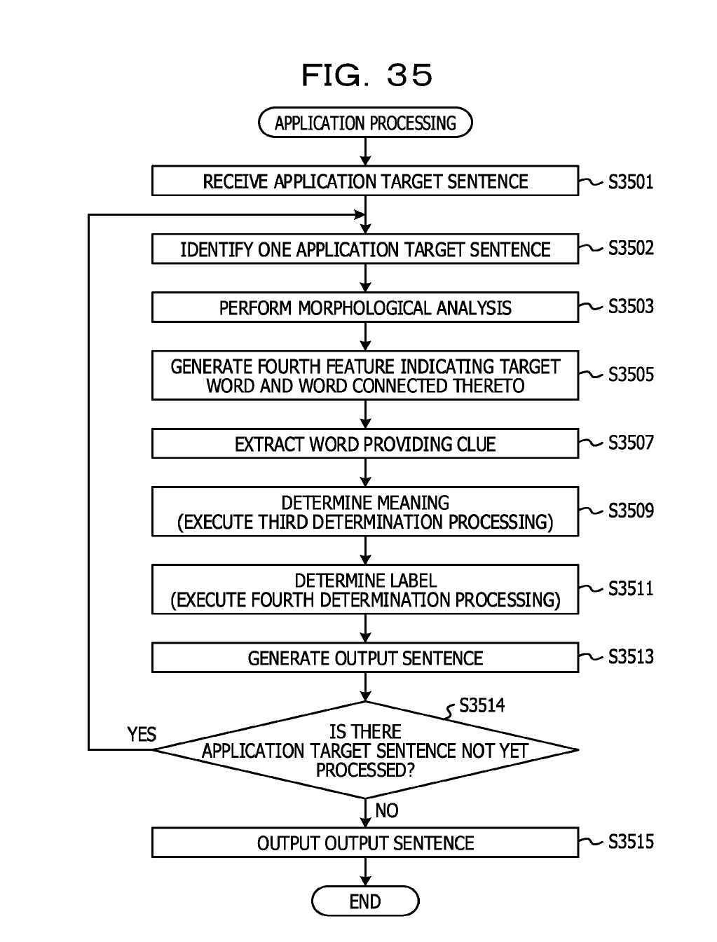

FIG. 35 illustrates an example of the application processing flow. The second reception unit 3405 receives the application target sentence, for example, via a storage medium, a communication medium, or an input device (S3501). The received application target sentence is stored in the fourth sentence storage unit 3407. One application target sentence corresponds to one application example.

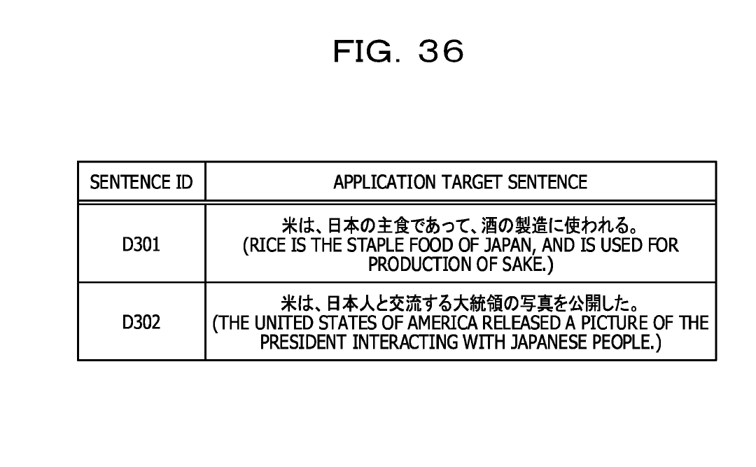

FIG. 36 illustrates an example of application target sentence data. The target sentence data is provided with a record for each of application target sentences. The record stores the application target sentence by associating with the sentence ID.

The application target sentence “ [symbol] [symbol] [symbol] [symbol] ” (rice is the staple food of Japan and is used for production of sake) (sentence ID: D301) stored in the first record in the example of FIG. 36 is the same as the sentence illustrated in the upper part of FIG. 2.

The application target sentence “ [symbol] [symbol] [symbol] [symbol] ” (The United States of America released a picture of the president interacting with Japanese people) (sentence ID: D302) stored in the second record in the example of FIG. 36 is the same as the sentence illustrated in the upper part of FIG. 1.

Description is continued by referring back to FIG. 35. The third generation unit 3409 identifies one of application target sentences stored in the fourth sentence storage unit 3407 (S3502). The third generation unit 3409 performs morphological analysis of the identified application target sentence (S3503).

The third generation unit 3409 generates a fourth feature identifying the target word or a word connected to the target word from the result of morphological analysis (S3505). The fourth feature corresponds to the second feature in training data. In this example, the third generation unit 3409 generates, by focusing on the target word, a fourth feature identifying the target word W(0), a fourth feature identifying the word W(1) next to the target word, and a fourth feature identifying the second next word W(2) following the target word. The third generation unit 3409 sets the generated fourth features to the record of application data stored in the application data storage unit 3417.

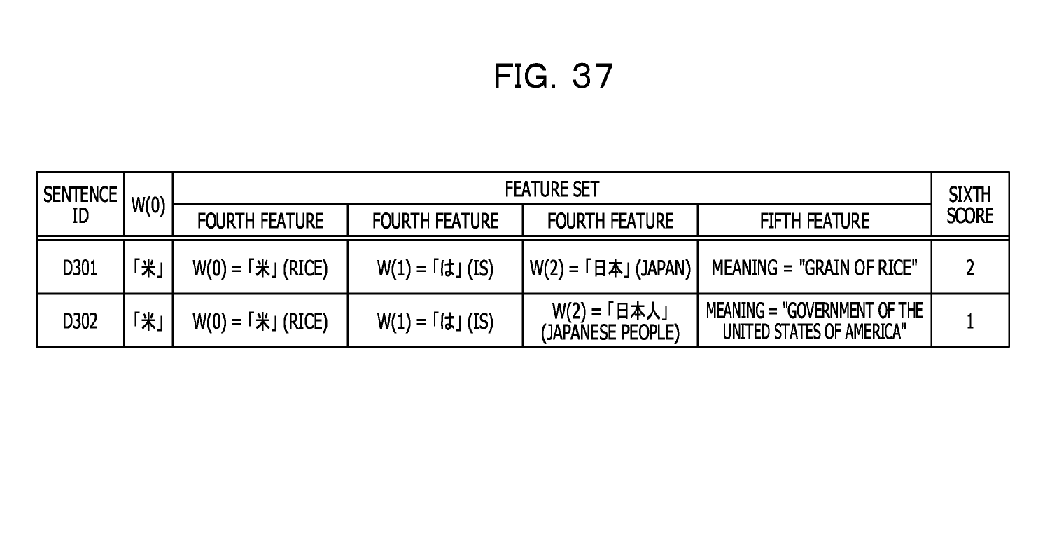

FIG. 37 illustrates an example of the application data. The application data includes a record corresponding to each word of the application target sentence. However, in this example, the target word is focused, and a record corresponding to a word other than the target word is omitted. In this example, the record of the application data includes a field for setting the ID of the application target sentence, a field for setting the focused word, a field for setting three fourth features, a field for setting the fifth feature, and a field for setting the sixth score.

The fourth feature is a feature which identifies the focused word and a word connected to the focused word as described above. The three fourth features correspond to three second features in the training data illustrated in FIG. 28.

The fifth feature is a feature identifying the meaning of the focused word. However, when the focused word is not the target word, the fifth feature is not set. That is, the fifth feature corresponds to the third feature in the training data illustrated in FIG. 28.

Thus, in the example of FIG. 37, a feature set comprising three fourth features and a fifth feature is set.

The sixth score is a score assigned when determining the meaning of the focused word. The sixth score indicates a weight (accuracy of evaluation) with respect to the meaning determination. That is, the sixth score corresponds to the fourth score in the training data illustrated in FIG. 28.

The first record in the example of FIG. 37 is a record corresponding to a first word in the application target sentence of the sentence ID D301. That is, in this record, a first word in the application target sentence of the sentence ID D301 is focused. In the first record in the example of FIG. 37, a fourth feature indicating that the focused word W(0) matches a first word in the application target sentence of the sentence ID D301, a fourth feature indicating that a word W(1) next to the focused word matches a second word in the application target sentence of the sentence ID D301, and a fourth feature indicating that a second next word W(2) following the focused word matches a third word in the application target sentence of the sentence ID D301 are set. Further, in the first record in the example of FIG. 37, a fifth feature indicating that the meaning of the focused word W(0) is “grain of rice”, and a sixth score “2” obtained when determining the meaning “grain of rice” of the focused word W(0) are set.

The second record in the example of FIG. 37 is a record corresponding to a first word in the application target sentence of the sentence ID D302. That is, in this record, a first word in the application target sentence of the sentence ID D302 is focused. In the second record in the example of FIG. 37, a fourth feature indicating that the focused word W(0) matches a first word in the application target sentence of the sentence ID D302, a fourth feature indicating that a word W(1) next to the focused word matches a second word in the application target sentence of the sentence ID D302, and a fourth feature indicating that a second next word W(2) following the focused word matches a third word in the application target sentence of the sentence ID D302 are set. Further, in the second record in the example of FIG. 37, a fifth feature indicating that the meaning of the focused word W(0) is “government of The United States of America”, and a sixth score “1” obtained when determining the meaning “government of The United States of America” of the focused word W(0) are set.

Description is continued by referring back to FIG. 35. The fourth extraction unit 3411 extracts a word providing a clue for the meaning determination from the result of morphological analysis (S3507). The clue word contained in the application target sentence is a noun other than the target word contained in the application target sentence. The clue word is set into a record of the fourth extracted data stored in the fourth extracted data storage unit 3413.

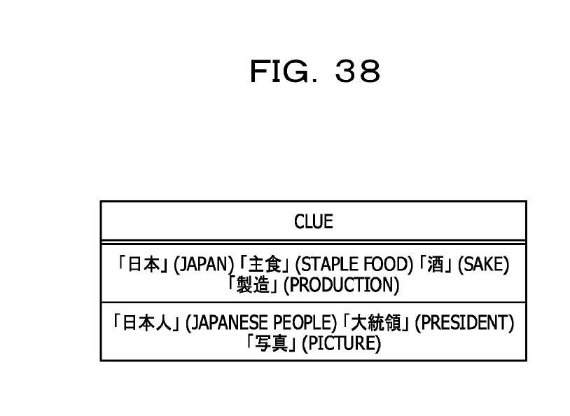

FIG. 38 illustrates an example of the fourth extracted data. The fourth extracted data includes a record corresponding to the application target sentence. A record of the fourth extracted data includes a field for setting the clue word contained in the application target sentence. The clue word contained in the application target sentence is a noun other than the target word contained in the application target sentence.

In the first record in the example of FIG. 38, clue words “ [symbol] ” “ [symbol] [symbol] ” “ [symbol] ” and “ [symbol] ” extracted from the application target sentence of the sentence ID D301 are set.

In the second record in the example of FIG. 38, clue words “ [symbol] ” “ [symbol] ” and “ [symbol] ” extracted from the application target sentence of the sentence ID D302 are set.

Description is continued by referring back to FIG. 35. The third determination unit 3415 determines the meaning of the target word contained in the application target sentence identified in S3502, by applying the fourth extracted data to the meaning determiner generated by the learning apparatus 301 (S3509). In this embodiment, the meaning determination processing in S3509 is referred to as the third determination processing.

Input of the meaning determiner corresponds to the clue in the fourth extracted data, and output thereof corresponds to the meaning in the fourth extracted data. The third determination unit 3415 calculates the sixth score for each meaning in accordance with the first rule data. Then, the third determination unit 3415 selects a meaning having a larger value of the sixth score. The selected meaning is set to a record of the application data stored in the application data storage unit 3417 as the fifth feature. The sixth score of the selected meaning is also set to a record of the application data stored in the application data storage unit 3417.

The fourth determination unit 3419 determines the label of the target word contained in the application target sentence identified in S3502, by applying the application data to the label determiner generated by the learning apparatus 301 (S3511). In this embodiment, the label determination processing in S3511 is referred to as the fourth determination processing.

Input of the label determiner corresponds to the feature set in the application data (in this example, three fourth features and a fifth feature), and output thereof corresponds to the label in the application data. The fourth determination unit 3419 calculates a seventh score for each label in accordance with the third rule data. Simply, the seventh score is calculated by summing up fifth scores (see the third rule data of FIG. 30) allocated to the corresponding features among fourth features and fifth features for each record of application data. When the label corresponds to the fifth feature, the fourth determination unit 3419 may multiply a sixth score corresponding to the fifth feature by the fifth score and add the obtained product. That is, the fourth determination unit 3419 may use the sixth score as the importance of the fifth feature in each of application examples.

The seventh score for each of calculated labels is set to a record of the result data stored in the result data storage unit 3421. Then, the fourth determination unit 3419 selects a label having a larger value of the seventh score. The selected label is also set into a record of the result data stored in the result data storage unit 3421.

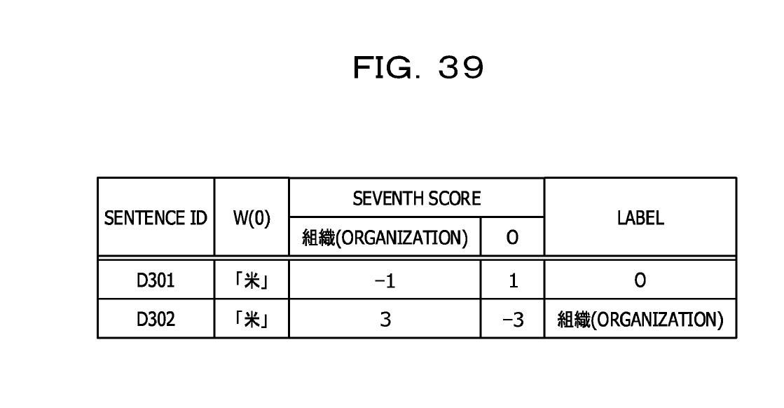

FIG. 39 illustrates an example of the result data. The result data includes a record corresponding to each word of the application target sentence. However, in this example, the target word is focused, and a record corresponding to a word other than the target word is omitted. In this example, the record of the result data includes a field for setting the sentence ID, a field for setting the focused word, a field for setting the seventh score assigned to each label, and a field for setting the selected label.

The first record in the example of FIG. 39 indicates that when the target word contained in the application target sentence of the sentence ID D301 is focused, the seventh score “−1” is assigned to the label “ [symbol] ” (ORGANIZATION), and the seventh score “1” is assigned to the label “ [symbol] ”. Then, the first record also indicates that the label “ [symbol] ” having a larger value of the seventh score is selected.

The second record in the example of FIG. 39 indicates that when the target word contained in the application target sentence of the sentence ID D302 is focused, the seventh score “3” is assigned to the label “ [symbol] ” (ORGANIZATION), and the seventh score “−3” is assigned to the label “ [symbol] ”. Then, the second record also indicates that the label “ [symbol] ” (ORGANIZATION) having a larger value of the seventh score is selected.

Description is continued by referring back to FIG. 35. The fourth generation unit 3423 generates the output sentence (S3513). Specifically, when the label of the target word contained in the application target sentence identified in S3502 is “ [symbol] ” (ORGANIZATION), a tag indicating the type of unique expression “ [symbol] ” (ORGANIZATION) is added to the target word. Meanwhile, when the label of the target word contained in the application target sentence identified in S3502 is “ [symbol] ”, no tag is added. However, tags < [symbol] > and </ [symbol] > indicating that the label does not fall under the type of the unique expression may be added.

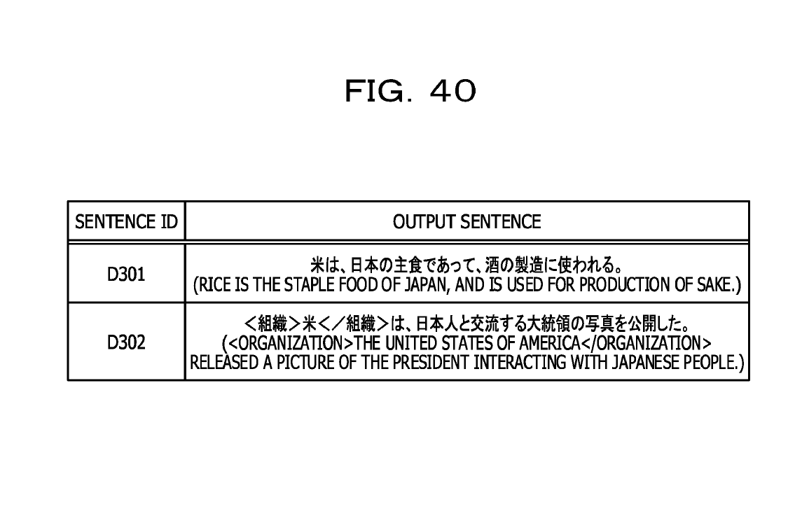

FIG. 40 illustrates an example of the output data. The output data includes a record for each of output sentences. In the first record in the example of FIG. 40, the output sentence corresponding to the application target sentence of the sentence ID D301 is stored. The output sentence corresponding to the application target sentence of the sentence ID D301 is the same as the sentence illustrated in the upper part of FIG. 2.

In the second record in the example of FIG. 40, the output sentence corresponding to the application target sentence of the sentence ID D302 is stored. The output sentence corresponding to the application target sentence of the sentence ID D302 is the same as the sentence illustrated in the lower part of FIG. 1.

Description is continued by referring back to FIG. 35. The third generation unit 3409 determines whether there is an application target sentence not yet processed (S3514). If determined that there is an application target sentence not yet processed, operation returns to the processing of S3502 and repeats the above processing.

Meanwhile, when determined that there is no application target sentence not yet processed, the output unit 3427 outputs the output sentence (S3515). The output mode is, for example, writing, displaying or transmitting into a recording medium.

According to an aspect of this embodiment, a rule for performing more correct type classification of a word having a plurality of meanings is obtained based on the automatically determined meaning of the target word. As the context of the second example sentence serving as a basis of the second rule data is common with the context of the first example sentence serving as a basis of the first rule data, inconsistency in the second rule data is unlikely to occur. Further, as the second rule data is used as a default value of the rule data (coupled load), rule of the label determination based on the meaning is likely to be maintained properly.

Further, as an evaluation value of the meaning used as the determination basis in the second determination processing (S2711 in FIG. 27) is used as the importance of the meaning in learning in the third learning processing (S2717 in FIG. 27), accuracy of the meaning determination may be reflected on the label determination.

Further, as the first example sentence is acquired from the web site, it is easy to obtain standard first rule data.

Further, as the type of unique expression is determined, it is useful to identify a word pertaining to the unique expression.

### Second Embodiment

In the embodiment described above, an example of providing the determination device 3401 separately from the learning apparatus 301 is illustrated. However, the learning apparatus 301 may be configured to also serve as the determination device 3401.

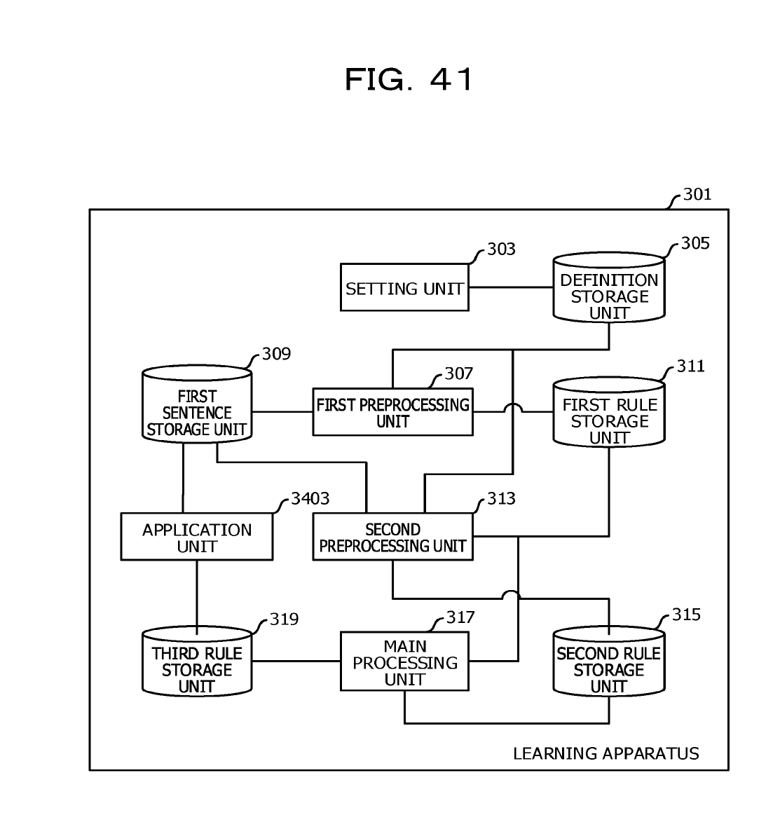

FIG. 41 illustrates a module configuration example of a learning apparatus 301 according to the second embodiment. In this example, the application unit 3403 provided in the determination device 3401 according to the first embodiment is provided in the learning apparatus 301.

Configuration and processing of the application unit 3403 are the same as in the first embodiment.

According to an aspect of this embodiment, the application unit 3403 enables the learning apparatus 301 to classify a word having a plurality of meanings into a correct type.

In the above, the embodiment is described by using the type of unique expression “ORGANIZATION” as an example. However, the same processing as for “ORGANIZATION” applies to other types such as “personal name” and “geographical name”. The type of unique expression is one example for the type of word distinguished by the label.

The type of word may be a part of speech. That is, the part of speech may be distinguished by the label.

The type of word may be the reading (for example, Chinese reading and Japanese reading). That is, the pronunciation may be distinguished by the label.

Further, the type of word may be intonation, pronunciation or accent of the word. That is, intonation, pronunciation or accent may be distinguished by the label.

In the above, application examples in Japanese words are illustrated. However, this embodiment may be applied to other languages as well. For example, the embodiment may be applied to Chinese, Spanish, English, Arabic, or Hindi.

Although the embodiments are described as above, but these are not limiting. For example, the functional block configuration described above may not match a program module configuration.

Also, the configuration of respective storage regions described above is just an example, and is not be limited thereto. Further, if there is no change of the processing result, the order of processing may be changed and a plurality of processings may be executed in parallel in a processing flow.

The learning apparatus 301 and the determination device 3401 described above are computer devices, and as illustrated in FIG. 42, a memory 2501, a central processing unit (CPU) 2503, a hard disk drive (HDD) 2505, a display controller 2507 connected to a display device 2509, a drive device 2513 for a removable disk 2511, an input device 2515, and a communication controller 2517 for connecting to the network are connected thereto via a bus 2519. The operating system (OS) and an application program for performing processings according to the embodiment are stored in the HDD 2505, and are read from the HDD 2505 to the memory 2501 when executed by the CPU 2503. The CPU 2503 controls a display controller 2507, a communication controller 2517, and a drive device 2513 to perform a predetermined operation according to the processing content of an application program. Data being processed is predominantly stored in the memory 2501, but may be stored in the HDD 2505. In the embodiments, an application program for performing processings described above is distributed by storing in the computer readable removable disk 2511, and installed on the HDD 2505 from the drive device 2513. Also, the application program may be installed on the HDD 2505 via a network or the communication controller 2517 such as on the internet. Such computer devices achieve various functions as described above by organic collaboration among the hardware such as the CPU 2503 and the memory 2501, the OS, and the program such as an application, as described above.

The embodiments described above are summarized below.

The learning apparatus according to this embodiment learns a rule of determining the type of a target word having a plurality of meanings and classified to a plurality of types. The above learning apparatus includes a first learning unit configured to learn a first rule determining the meaning of the target word based on a first example sentence containing the target word and first data identifying the meaning of the target word, a first determination unit configured to determine the meaning of the target word in a second example sentence which is common to a context of the first example sentence and includes the target word and data identifying the type of the target word in accordance with the first rule, a second learning unit configured to learn a second rule identifying the type based on the association between the meaning in the second example sentence and the type identified by the data, a second determination unit configured to determine the meaning of the target word in a third example sentence containing the target word and another data identifying the target word in accordance with the first rule, and a third learning unit configured to learn a third rule identifying the type based on the meaning in the third example sentence and the third example sentence by using the second rule as a default value.

Thus, a rule for performing more correct type classification of a word having a plurality of meanings is obtained based on the automatically determined meaning of the target word. As the context of the second example sentence serving as a basis of the second rule is common to the context of the first example sentence serving as a basis of the first rule, inconsistency in the second rule is unlikely to occur. Further, as the second rule is used as a default value, the rule of type determination based on the meaning may be maintained easily.

The above learning apparatus may include a third determination unit configured to determine the meaning of a target word in an application target sentence containing the target word in accordance with the first rule. Further, the above learning apparatus may include a fourth determination unit configured to determine the above type in an application target sentence in accordance with the third rule based on the determined meaning and the application target sentence.

Thus, the learning apparatus may classify a word having a plurality of meanings into a type in a more correct manner.

The third learning unit may use an evaluation value of the meaning serving the determination basis of the second determination unit as the importance of the meaning in learning.

Thus, the likelihood of the meaning determination may be reflected on determination of the type.

The learning apparatus may include an acquisition unit configured to acquire a first example sentence from a web site.

Thus, a standard first rule may be obtained easily.

The plurality of types may include one type in the unique expression.

Thus, it is useful to identify a word pertaining to the unique expression.

A program for causing a computer to execute processings in the learning apparatus described above may be created, and the program may be stored, for example, in a computer readable storage medium or storage device such as a flexible disk, a CD-ROM, an optical magnetic disk, a semiconductor memory, and hard disk. In general, intermediate processing result is temporarily stored in a storage device such as a memory.

All examples and conditional language recited herein are intended for pedagogical purposes to aid the reader in understanding the invention and the concepts contributed by the inventor to furthering the art, and are to be construed as being without limitation to such specifically recited examples and conditions, nor does the ORGANIZATION of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A learning apparatus comprising:
a memory; and
a processor coupled to the memory and configured to:
generate, based on a first example sentence containing a target word having a plurality of meanings belonging to different types, a first rule containing a first meaning of the target word in the first example sentence, and another word providing a clue for determining the first meaning,
acquire a second example sentence having a context similar to that of the first example sentence, the second example sentence containing the target word and data identifying a type of a second meaning of the target word,
determine the second meaning of the target word in the second example sentence based on a word contained in the second example sentence and the first rule,
generate a second rule pertaining to a correlation between the second meaning and the type based on the second meaning of the target word in the second example sentence and the data,
acquire a third example sentence containing the target word and another data identifying a type of a third meaning of the target word,
determine the third meaning of the target word in the third example sentence based on a word contained in the third example sentence and the first rule, and
learn a third rule for determining a type of the target word based on the second rule, the third meaning, and the third example sentence.

2. The learning apparatus according to claim 1, wherein the plurality of meanings include a meaning as unique expression and a meaning other than the unique expression.

3. The learning apparatus according to claim 2, wherein the types include a type indicating to be the unique expression and a type indicating not to be the unique expression.

4. The learning apparatus according to claim 2, wherein the type indicating to be the unique expression is further set for each kind of the unique expression.

5. The learning apparatus according to claim 1, wherein the third rule is learned based on the third meaning and the third example sentence by using the second rule as a default value.

6. The learning apparatus according to claim 5, wherein
the processor is configured to:
determine a fourth meaning of the target word in a new sentence containing the target word in accordance with the first rule,
determine a type of the fourth meaning of the target word in the new sentence based on the fourth meaning, the new sentence, and the third rule, and
output a determined result.

7. The learning apparatus according to claim 5, wherein
the processor is configured to use an evaluation value of the second meaning as importance in learning of the third rule.

8. The learning apparatus according to claim 1, wherein the first example sentence is acquired from a web site.

9. A learning method comprising:
generating, based on a first example sentence containing a target word having a plurality of meanings belonging to different types, a first rule containing a first meaning of the target word in the first example sentence, and another word providing a clue for determining the first meaning;
acquiring a second example sentence having a context similar to that of the first example sentence, the second example sentence containing the target word and data identifying a type of a second meaning of the target word;
determining the second meaning of the target word in the second example sentence based on a word contained in the second example sentence and the first rule;
generating a second rule pertaining to a correlation between the second meaning and the type based on the second meaning of the target word in the second example sentence and the data;
acquiring a third example sentence containing the target word and another data identifying a type of a third meaning of the target word;
determining the third meaning of the target word in the third example sentence based on a word contained in the third example sentence and the first rule; and
learning a third rule for determining a type of the target word based on the second rule, the third meaning, and the third example sentence by a processor.

10. The learning method according to claim 9, wherein the plurality of meanings include a meaning as unique expression and a meaning other than the unique expression.

11. The learning method according to claim 10, wherein the types include a type indicating to be the unique expression and a type indicating not to be the unique expression.

12. The learning method according to claim 10, wherein the type indicating to be the unique expression is further set for each kind of the unique expression.

13. The learning method according to claim 9, wherein the third rule is learned based on the third meaning and the third example sentence by using the second rule as a default value.

14. The learning method according to claim 13, further comprising:
determining a fourth meaning of the target word in a new sentence containing the target word in accordance with the first rule;
determining a type of the fourth meaning of the target word in the new sentence based on the fourth meaning, the new sentence, and the third rule; and
outputting a determined result.

15. The learning method according to claim 13, further comprising:
using an evaluation value of the second meaning as importance in learning of the third rule.

16. The learning method according to claim 9, wherein the first example sentence is acquired from a web site.

17. A non-transitory computer-readable storage medium storing a learning program which causes a computer to execute a process, the process comprising:
generating, based on a first example sentence containing a target word having a plurality of meanings belonging to different types, a first rule containing a first meaning of the target word in the first example sentence, and another word providing a clue for determining the first meaning;
acquiring a second example sentence having a context similar to that of the first example sentence, the second example sentence containing the target word and data identifying a type of a second meaning of the target word;
determining the second meaning of the target word in the second example sentence based on a word contained in the second example sentence and the first rule;
generating a second rule pertaining to a correlation between the second meaning and the type based on the second meaning of the target word in the second example sentence and the data;
acquiring a third example sentence containing the target word and another data identifying a type of a third meaning of the target word;
determining the third meaning of the target word in the third example sentence based on a word contained in the third example sentence and the first rule; and
learning a third rule for determining a type of the target word based on the second rule, the third meaning, and the third example sentence.
